(19) United States
(12) Patent Application Publication
(10) Pub. No.: US 2002/0177428 A1
(43) Pub. Date: Nov. 28, 2002

(54) Remote notification of monitored condition

(76) Inventors: Raymond J. Menard, Hastings, MN (US); Curtis E. Quady, Burnsville, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/112,690

(22) Filed: Mar. 28, 2002

Related U.S. Application Data
(60) Provisional application No. 60/279,516, filed on Mar. 28, 2001.
(60) Provisional application No. 60/279,519, filed on Mar. 28, 2001.

(51) Int. Cl. H04M 11/00

(52) U.S. Cl. 455/404; 455/414

(57) ABSTRACT

Distribution and management of detected alarm signals using multiple communication channels for each of a plurality of authorized data recipients. Wired or wireless communication channels are used to transfer alarm notification messages and responses by the authorized data recipient. Responses include messages to cancel or confirm. Notification of receipt of an alarm response message is communicated to authorized data recipients via the multiple communication channels which may include a two-way pager, a cellular telephone or an e-mail address.

### RELATED APPLICATIONS

This application claims priority to U.S. Provisional Application serial No. 60/279,516 (entitled REMOTE NOTIFICATION OF MONITORED CONDITION, and filed on Mar. 28, 2001), the specification of which is herein incorporated by reference.

This application claims priority to U.S. Provisional Application serial No. 60/279,519 (entitled MESSAGE MANAGEMENT SYSTEM AND METHOD, and filed on Mar. 28, 2001), the specification of which is herein incorporated by reference.

This application claims priority to U.S. patent application Ser. No. 09/219,737 (entitled DETECTION SYSTEM USING PERSONAL COMMUNICATION DEVICE WITH RESPONSE, and filed on Dec. 22, 1998), the specification of which is herein incorporated by reference, which claims priority to U.S. Provisional Application serial No. 60/098,270 (entitled DETECTION SYSTEM USING CONFERENCE MONITORING, and filed on Aug. 28, 1998), the specification of which is herein incorporated by reference.

This application claims priority to U.S. patent application Ser. No. 09/793,373 (entitled EMERGENCY RESPONSE INFORMATION DISTRIBUTION, and filed on Feb. 26, 2001), the specification of which is herein incorporated by reference.

### TECHNICAL FIELD

The document relates generally to security, alarm or detection systems and wireless networks and in particular to the use of remote messaging, using, for example, long range, bidirectional, wireless networks.

### BACKGROUND

In the security alarm industry, detection devices at a premise detect various conditions at the premise. These conditions may indicate that a fire, burglary, medical, environmental or other condition exists. The security system then transmits the information to a central response center (central station) that then coordinates the response activities of others back to the premise. However, many alarms are false, which results in needless dispatching of police, fire and medical teams. This creates numerous problems for public response agencies, endangers public safety and increases costs to consumers and industry providers;

As a result, some central dispatch centers attempt to place a telephone call to the premise in an effort to communicate with the alarm user to determine if the alarm reported is false. If falsity cannot be established, then the central dispatch contacts an emergency response service and authorities are dispatched. Despite these efforts, statistics show that on average, more than 95% of all reported alarms are false.

What is needed is an improved system that reduces the costs associated with false alarms.

### SUMMARY

In one embodiment, the present subject matter provides nearly simultaneous communication of an alarm notification signal to one or more remote users via multiple communication channels.

Consider a home security system with a commercially provided monitoring service. Assume that the protected home has three responsible parties, namely Adult A, Adult B and Adult C. A processor at the monitoring service maintains a computerized list of contact numbers and addresses for each responsible party. For example, the list for Adult A may include a cellular telephone number, an office telephone number and an e-mail address. The list for Adult B may include a home telephone number, a two-way pager and a facsimile machine. The list for Adult C may include a cellular telephone number and a trunked radio channel.

When the monitoring service receives an alarm signal from the protected home, the processor accesses the call lists for Adult A, Adult B and Adult C and transmits an alarm message to each number or address on the list. Thus, for Adult A, the cellular telephone will begin to ring, the office telephone will ring and an incoming e-mail message will appear. For Adult B, the home telephone number will ring, a message will be sent to the two-way pager and a message will be transmitted to the facsimile machine. For Adult C, the cellular telephone will ring and the trunked radio will receive a call. At this point, the monitoring service awaits a reply from the first of either Adult A, Adult B or Adult C. Assume Adult B receives the alarm message on the two-way pager and he is the first to reply by operating a user-accessible key on the pager. The reply message sent to the monitoring center indicates that the alarm is to be cancelled. In this case, the monitoring service, after authenticating the reply from the pager of Adult B, will discard, or otherwise ignore, the alarm signal. The monitoring service, in this case, does not call the public safety answering point (PSAP). An audible alarm sounding at the protected home, nevertheless, may continue to signal an alarm. The monitoring service, after having authenticated the reply from Adult B, then transmits an update message to each of Adult A and Adult C. In one embodiment, a message is transmitted to Adult B to confirm receipt of the cancellation signal sent from the two-way pager. The update messages to Adult A and Adult C may indicate that Adult B has already supplied a cancellation command, and that no further action is expected.

If, on the other hand, Adult B transmits a “confirm alarm” signal using the two-way pager, then the processor at the monitoring service proceeds to transmit a request for assistance to the PSAP. A message is then transmitted to the call lists for Adult A and Adult C to indicate that the alarm signal has been verified by Adult B. Adult B may receive a confirmation signal. The monitoring service may send a message to Adult A, Adult B and Adult C requesting that one of the adults meet an authority at the premises.

In one embodiment, an incoming message is received by a first interface coupled to the processor and an outgoing message is transmitted by a second interface coupled to the processor. The incoming and outgoing interfaces may include a telephone line connection, an Internet connect, a wireless radio transceiver and other hardware and systems adapted to perform the functions described herein.

Other variations of the present subject matter are also contemplated.

In one embodiment, the present subject matter provides nearly simultaneous communication of an alarm status signal to one or more remote users via multiple communication channels. The status signal may indicate the outcome of an alarm notification signal.

Disclosed herein is a system and method for remote notification of a monitored condition. The alarm may include a coded or uncoded signal associated with an emergency or non-emergency event or condition. Examples of alarms include a burglar alarm, a fire alarm or a medical emergency alarm. Other sensors may also generate an alarm signal, such as, for example, mechanical, environmental, maintenance, usage, access or other type of sensor. Alarms may be triggered by one or more sensors located in or on an object or premise or an alarm may be manually triggered by a person. The alarm may result in the dispatch of emergency or service personnel. An alarm event may include a single detected instance or occurrence, for example, and an alarm condition, for example, may indicate persistent detected status. In one embodiment, alarm events are treated as alarm conditions.

An alarm may be generated by a vehicle, object, or person. An alarm may be associated with a mobile or fixed location.

In some cases, the alarm signal is monitored by a central station. For example, a fire alarm signal may be communicated to a central station for further dispatch to a fire department or other emergency personnel. In one embodiment, the alarm signal is communicated to a central monitoring station or location, via wired or wireless technology. In one embodiment, the alarm signal is communicated (directly or indirectly) from the alarm system to a responsible party (RP). The RP may be one of a plurality of RPs that are notified of art alarm event or condition using a narrowcast method. The RP(s) are authorized or able to take action relative to the alarm event or condition. For example, the RP may be a neighbor or relative of the homeowner associated with the premises that generated the alarm signal.

In one embodiment, an RP is notified of an alarm event or condition for the purpose of seeking verification of the alarm or cancellation of the planned response to the alarm. Cancellation of the planned response to the alarm, in one embodiment, includes aborting or terminating dispatch of emergency personnel. In one embodiment, an RP is notified of an alarm event or condition for the purpose of initiating follow up or taking action relating to the alarm event or condition. For example, the RP may be asked to meet emergency personnel at the alarm site or tend to a broken entry door or window.

In one embodiment, the RP is notified by a facsimile transmission, a pager message, an e-mail message, a cellular telephone message or a telephone message using plain old telephone service (POTS). In one embodiment, a pager message may be transmitted using various protocols, such as one-way protocol, short message service (SMS), a wireless application protocol (WAP), or a two-way pager protocol. In one embodiment, the notification includes interactive voice messaging which allows the RP to engage in an interactive dialog to retrieve salient information regarding the alarm condition.

In one embodiment, various devices are used to communicate the notification to the RP, including for example, a personal digital assistant (PDA), a personal computer, a facsimile machine, a pager, a cell phone, or an ordinary telephone.

In one embodiment, the group of RPs that are to be notified of a particular alarm condition or event may of any size. For example, a group may include family members or officers of a corporation. The group may also include a selected subset of employees, neighbors, responding agencies, maintenance or service providers or others. The notification of multiple parties, or transmitting to multiple addresses, is known as “narrowcasting.”

In one embodiment, the notification message is decoded, or translated into an alternative native language, prior to transmission.

In one embodiment, the notification is forwarded to the RP as a one-way message with no expectation of a reply. In one embodiment, the notification is forwarded to the RP as a two-way message and includes a request for a response from the RP. The present system determines if a reply or response is requested and presents it to a dispatcher as needed. The narrowcasting of messages may operate in a parallel fashion with multiple simultaneous transmissions to multiple RPs. This narrowcast method increases the likelihood of a message reaching an RP so that the RP can cancel or validate an alarm event in a timely manner, thus preventing false dispatching of agencies (which is significant cost and safety issue) or assuring a rapid response to a valid alarm.

In one embodiment, multiple messages are sent simultaneously (or nearly simultaneously), that is, narrow cast to multiple RPs and/or multiple addresses at one time, solving the problem of manual serial notification, which may require a significant time before the list of RPs is exhausted, thus, prolonging the response time. Indeed a serial approach may further threaten lives or property in a time critical situation.

One embodiment of the present method and system of monitoring permits multiple attempts to reach multiple RPs with each RP having multiple contact numbers or access information. For example, a single RP may have a home telephone number, a work telephone number, a cellular telephone number, a pager telephone number, an e-mail address, a facsimile machine telephone number and a radio communication channel. In one embodiment, the alarm notification signal is transmitted simultaneously or nearly simultaneously, and automatically, using each of the selected communication channels in an attempt to contact an RP. As noted above, the present system and method includes the ability to transmit an alarm notification message to multiple RPs, each having multiple contact numbers.

This summary is intended to provide a brief overview of some of the embodiments of the present system, and is not intended in an exclusive or exhaustive sense, and the scope of the invention is to be determined by the attached claims and their equivalents.

### BRIEF DESCRIPTION OF THE DRAWINGS

In the drawings, like numerals describe substantially similar components throughout the several views. Like numerals having different letter suffixes represent different instances of substantially similar components.

FIG. 1 includes a schematic diagram depicting an overview of the present system.

FIG. 2 includes a block diagram depicting a process according to the present system.

FIGS. 3A, 3B and 3C depict embodiments of alarm reception and processing pathways.

FIG. 4 includes a block diagram depicting an overview of the connections of the present system to users.

FIG. 5 includes a flow chart depicting an overview of converting an alarm signal into a notification message for an RP.

FIG. 6 includes a flow chart illustrating an alarm dispatch process.

FIG. 7 includes a flow chart illustrating an alarm dispatch process according to one embodiment of the present system.

FIG. 8 includes a flow chart illustrating a process according to one embodiment of the present system.

FIG. 9 includes a flow chart illustrating a process according to one embodiment of the present system.

FIG. 10 includes a flow chart illustrating retrieval of account information according to one embodiment of the present system.

FIG. 11 includes a flow chart illustrating accessing responding agency information associated with an alarm event.

FIG. 12 includes a flow chart illustrating translating a notification message in a first language into a second language.

FIG. 13 includes a flow chart illustrating security management in one embodiment of the present system.

FIG. 14 includes a flow chart illustrating updating of alarm information.

FIG. 15 includes a flow chart illustrating accessing of related alarm files.

FIG. 16 includes a flow chart illustrating accessing data links of users.

FIG. 17 includes a flow chart illustrating formatting a message for selected devices used by RPs or agencies.

FIG. 18 includes a flow chart illustrating sources of responses to messages.

FIG. 19 includes a flow chart illustrating selected uses of responses received from RPs and other users.

FIG. 20 includes flow chart illustrating using a timer in response management.

FIG. 21 includes a flow chart illustrating an interactive voice response application.

FIG. 22 includes a block diagram illustrating one embodiment of the present system in a distributed processing environment.

FIGS. 23A and 23B include a flow chart illustrating the use of a timer to manage RP response.

FIG. 24 includes a block diagram of an example embodiment of a system according to the present subject matter.

### DETAILED SYSTEM DESCRIPTION

This detailed description provides a number of different embodiments of the present system. The embodiments provided herein are not intended in an exclusive or limited sense, and variations may exist in organization, dimension, hardware, software, mechanical design and configuration without departing from the claimed invention, the scope of which is provided by the attached claims and equivalents thereof.

### Overview

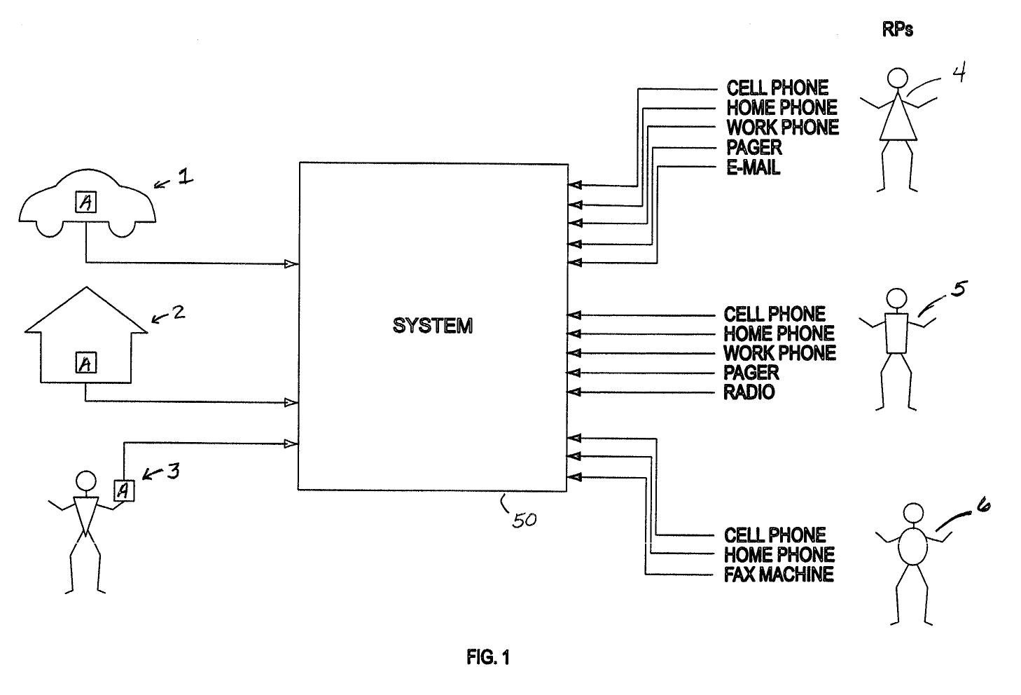

FIG. 1 illustrates one embodiment of the present system and method. In the figure, a central station is coupled to three representative alarm signal sources. Automobile theft alarm 1, residential fire or burglar alarm 2, and personal alarm 3 are independent alarm signal sources and each is in communication with system 50. Other alarm sources are also contemplated. In one embodiment, system 50 receives an alarm signal by a wireless or wired communication channel from an alarm signal source. Upon receiving an alarm signal, system 50 then attempts to contact a designated RP. In the figure, three RPs are depicted, each having several means of communicating. For example, RP 4 may be contacted by cellular telephone, a home telephone, a work telephone, a pager, or an e-mail address. In addition, RP 5 may be contacted by cellular telephone, a home telephone, a pager or a radio. In the embodiment shown, RP 6 may be contacted by cellular telephone, home telephone or a facsimile machine. Additional RPs may also be included, each having more or less alternative means of contacting.

In one embodiment, the customer of system 50 specifies or selects one or more call lists as well as the entries on each call list. In one embodiment, a call list includes the name of an RP as well as one or more access, addresses, or contact numbers for reaching that RP. For example, alarm source 2 may be associated with a call list for RP 4 and a call list for RP 5. One or more call lists per alarm source is contemplated. In one embodiment, a dispatcher manually attempts to contact an RP by accessing the entries in a call list.

In one embodiment, an RP receives a notification message sent by a wireless network to a user device. The user device may be of several different designs. For example, in one embodiment it may be a two-way pager adapted for response messaging. Using response messaging, a two-way pager receives a message and optional multiple-choice responses. The user, or RP, is prompted to ;elect a response for reply transmission by the wireless network. In one embodiment, a two-way pager is adapted to provide system control options to an RP.

In one embodiment, the user device includes a programmable two-way paging device such as the Motorola PageWriter™ 2000. This is a class of device that functions as both a two-way pager and a handheld computer also known as a PDA.

In another embodiment, the user device includes a cellular telephone. The cellular telephone may be analog or digital and compatible with one or more of several communication technologies. Exemplary cellular communication technologies include Personal Communications Services (PCS), or Code Division Multiple Access (CDMA), or Time Division Multiple Access (TDMN) or others. The cellular telephone may have programmable capability such as is found in a NokiaJ 9000 series of devices.

In one embodiment where the RP utilizes a pager or cell phone as the user device, a security password is entered by using numeric or other keys on a phone. In one embodiment, the security password includes a spoken word and the present system uses word recognition, voice recognition or a combination of word and voice recognition technologies. In one embodiment, a predetermined order or manner of pressing selected keys serves as a security password. For example, in one embodiment, the password includes pressing a selected key with three rapid pushes followed by a single long push. In one embodiment, the password includes one push on key “A” once on key “B” and once more on key “A.”

In one embodiment, the user device includes a handheld computer such as, for example, a PDA. Some PDAs offer programmable capability and connectivity to various types of long range wireless communication networks. One example a PDA includes the PalmPilot™ or Palm series of devices manufactured by 3-COM™. In one embodiment, a programmable user device is used, such as a PalmPilot, PageWriter or programmable cell phone and the programmable nature of the user device facilitates the implementation of industry-standard designs and allows for the development of a program written for the devices.

In one embodiment, the user device includes a communications module to connect to a long range, bidirectional network. Such a system includes a wireless communication network, such as a cellular network, satellite network, paging network, narrowband PCS, narrowband trunk radio, or other wireless communication network. Combinations of such networks and other embodiments may be substituted without departing from the present system.

In one embodiment, the long range wireless network includes a cellular communications network. In one embodiment, the long range wireless network is a paging network. In one embodiment the long range wireless network is a satellite network. In one embodiment the long range wireless network is a wideband or narrowband PCS network. In one embodiment the long range wireless network is a wideband or narrowband trunk radio module. Other networks are possible without departing from the present system. In one embodiment, the user device is compatible with a plurality of communication networks and includes a plurality of communications modules, such as, for example, a cellular module and a two-way paging module. In such embodiments, the present subject matter may prefer one form of network communication over another and may switch depending on a variety of factors such as available service, signal strength, or types of communications being supported. For example, the cellular network may be used as a default and the paging network may take over once cellular service is either weak or otherwise unavailable. Other permutations are possible without departing from the present system.

The long range wireless network employed may include a consumer or proprietary network designed to serve users in range of the detection system, including, but not limited to, a cellular network such as analog or digital cellular systems employing such protocols and designs as Cellular Digital Packet Data (CDPD), Code-division Multiple Access (CDMA), Global System for Mobile Communications (GSM), Personal Digital Cellular (PDC), Personal Handyphone System (PHS), Time-division Multiple Access (TDMA), FLEX™ (Motorola), ReFLEX™ (Motorola), iDEN™ (Motorola), TETRA™ (Motorola), Digital Enhanced Cordless Telecommunications (DECT), DataTAC™, and Mobitex™, RAMNET™ or Ardis™ or other protocols such as trunk radio, Microburst™, Cellemetry™, satellite, or other analog or digital wireless networks or the control channels or portions of various networks. The networks may be proprietary or public, special purpose or broadly capable. The foregoing include long range networks and the meaning imposed herein is not to describe a premises or facility based type of wireless network.

The long range wireless network may employ various messaging protocols. In one embodiment Wireless Application Protocol (WAP) is employed as a messaging protocol over the network. WAP is a protocol created by an international body representing numerous wireless and computing industry companies and is designed to work with most wireless networks such as CDPD, CDMA, GSM, PDC, PHS, TDMA, FLEX, ReFLEX, iDEN, TETRA, DECT, DataTAC, and Mobitex and also to work with some Internet protocols such as HTTP and IP. Other messaging protocols such as iMode™, WML, SMS and other conventional and unconventional protocols may be employed without departing from the design of the present embodiment.

As an example, these long range communication protocols described above may include, but are not limited to, cellular telephone protocols, one-way or two-way pager protocols, and PCS protocols. Typically, PCS systems operate in the 1900 MHZ frequency range. One example, known as CDMA (Qualcomm Inc., one variant is IS-95) uses spread spectrum techniques. CDMA uses the fill available spectrum and individual messages are encoded with a pseudo-random digital sequence. Another example, Global Systems for Mobile communications (GSM), is one of the leading digital cellular systems and allows eight simultaneous calls on the same radio frequency. Another example, TDMA (one variant known as IS-136) uses time-division multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages are limited to a length of 160 alpha-numeric characters. Another example, General Packet Radio Service (GPRS) is another standard used for wireless communications and operates al transmission speeds far greater than GSM. GPRS can be used for communicating either small bursts of data, such as e-mail and Web browsing, or large volumes of data.

In one embodiment, a long range communication protocol is based on one-way or two-way pager technology. Examples of one-way pager protocols include Post Office Code Standardisation Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/V/VI Formats (Multitone Electronics), Hexadecimal Sequential Code (HSC), FLEXTM (Motorola) format, Advanced Paging Operations Code (APOC, Philips Paging) and others. Examples of two-way pager protocols include ReFLEXTM (Motorola) format, InFLEXionÔ (Motorola) format, NexNetÔ (Nexus Telecommunications Ltd. of Israel) format and others.

Other long range communication protocols are also contemplated and the foregoing examples are not to be construed as limitations but merely as examples.

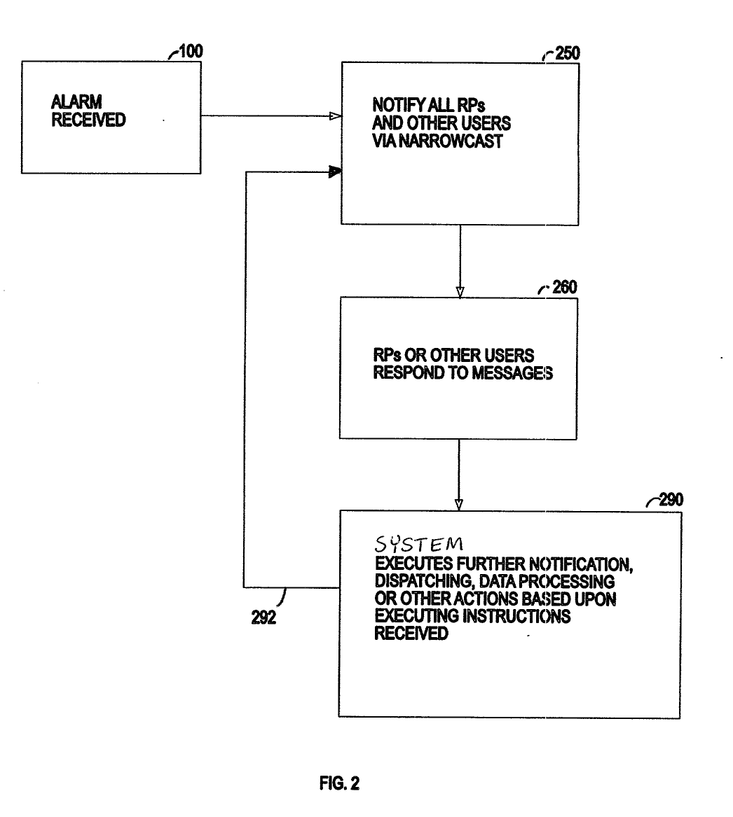

FIG. 2 includes an overview of a method according to one embodiment of the present subject matter. At 100, an alarm signal is received. At 250, the present system notifies all RPs and other users via narrowcast messaging. At 260, the RPs or other users respond to the messages. In one embodiment, the RPs or other users respond for the purpose of managing the alarm processing. At 290, the present system then executes the process which may included further notification, dispatching of one or more response agencies, data processing or other actions based upon executing the instructions for the particular RP, the monitoring account, or the alarm condition. In one embodiment, instructions are tailored for a particular customer at the time of establishing monitoring services or at a later time. In one embodiment, at 292, the process returns to 250 to commence another notification of all RPs and other users.

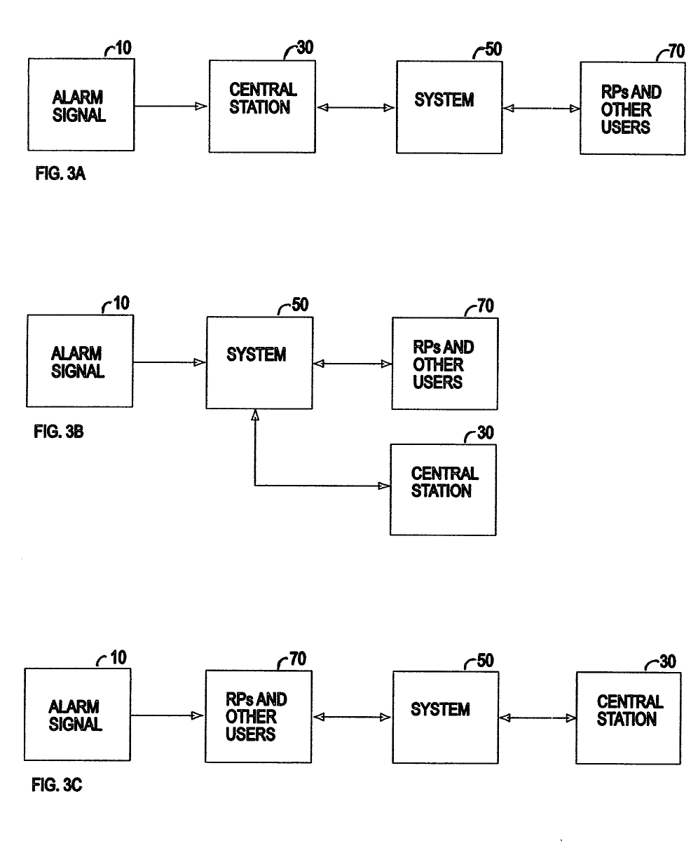

FIGS. 3A, 3B and 3C illustrate a process depicting alternate alarm reception and processing pathways. In both FIG. 3A and FIG. 3B, alarm signal 10 is forwarded to central station 30. From central station 30, a signal is communicated to system 50. System 50 and central station 30 interact to manage the dispatch process. At 70, system 50 notifies and receives messages from RPs and other users.

Other embodiments of the alarm reception and processing pathways are depicted in FIG. 3B and FIG. 3C. Combinations of these embodiments are possible without departing from the present embodiment. In FIG. 3C, the RP and other users are notified of the alarm condition first. In this embodiment, the RP and other users may forward the alarm to system 50 for further action if the RP and other users choose.

In one embodiment, the present system is integrated with the central station.

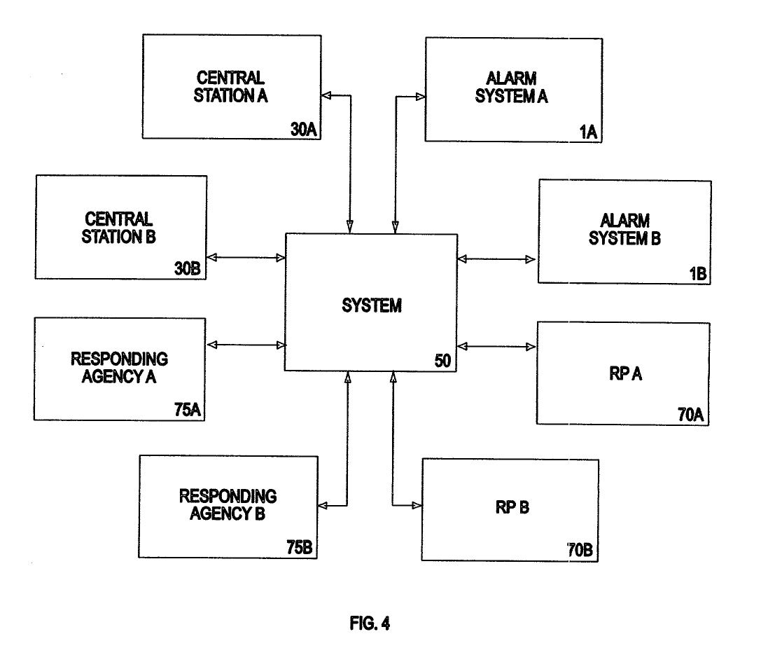

In one embodiment, a single system serves one or more central stations. FIG. 4 depicts this plurality of connections between multiple users of multiple types. For example, system 50 is in communication with central station 30A, central station 30B, responding agency 75A, responding agency 75B, alarm system 1A, alarm system 1B, responsible party 70A and responsible party 70B. In one embodiment, responding agency 75A and responding agency 75B may denote a PSAP, a fire emergency facility, a police emergency facility, a medical emergency facility or other such facility. Alarm system 1A and alarm system 1B, in one embodiment, represent an automobile security system, a home security system, a building management system, a commercial building security system, a personal security system or other such system. The communication channels between system 50 and the other elements appearing in FIG. 4 may include wired or wireless communication links. According to one embodiment, each entity coupled to system 50 of FIG. 4 is a user.

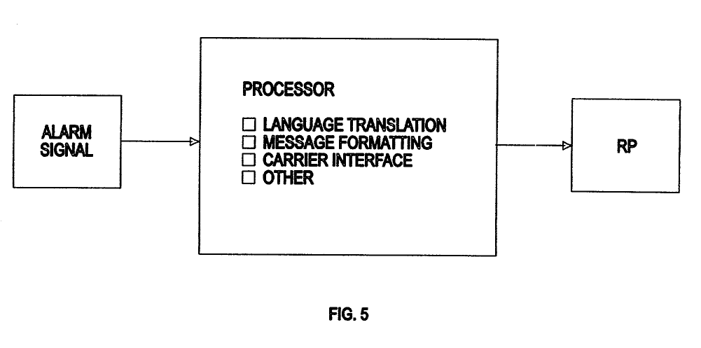

FIG. 5 illustrates, in block diagram form, an alarm signal arriving at a processor. The processor executes a set of instructions to perform predetermined functions, some of which are illustrated in the figure. The processor may be located at system 50 described with respect to FIG. 1. The processor, in one embodiment, encodes a message into a predetermined language in accordance with instructions from the user of the system. For example, a first RP may prefer to conduct communications in the German language and a second RP may prefer French. In one embodiment, the processor performs the language translation and also formats the message in a manner consistent with the communication carrier format. For example, in one embodiment, a message encoded for a pager is different from that encoded for transmission by e-mail. In one embodiment, the processor also provides the interface to the communication carrier. For example, the processor encodes the message for transmission using a pager or interactive voice using a telephone. Other functions are also performed by the processor, including, for example, implementing a hierarchy of priority for attempting to contact RPs as selected by the user of the system.

In one embodiment of the present invention, a message sent from the system service provider may be tagged with an identifier such as “you have an alarm message waiting.”

### Alarm Verification Processes

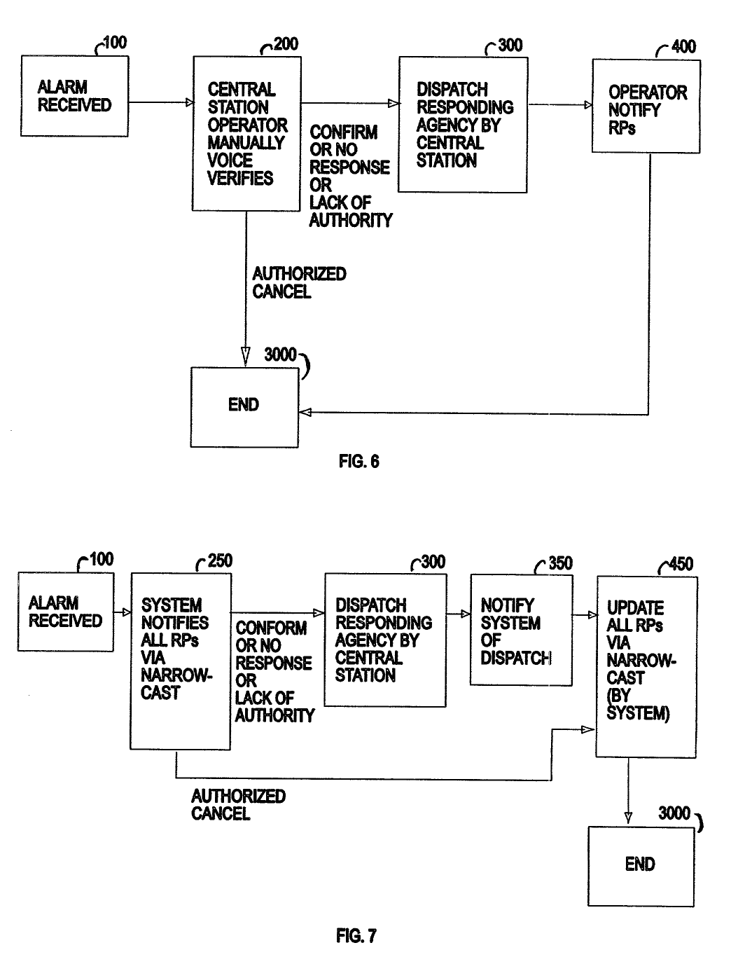

FIG. 6 depicts a portion of a dispatch process. At 100, an alarm signal is received in the central station. At 200, an operator or dispatcher at the central station manually attempts to verify the alarm condition. In one embodiment, the operator or dispatcher places a voice call to a contact number of a user of the alarm system in an attempt to verify the alarm. In one embodiment, the attempt to verify includes attempting to place a telephone call to the premise. The method proceeds based on the outcome encountered with the attempt to verify. In the attempt to verify the alarm, if the operator or dispatcher receives an authorized cancel response, then the procedure ends at 3000 without dispatching an emergency response. In the attempt to verify the alarm, if the operator or dispatcher receives a confirmation response, a no response, or a lack of authority response, then, at 300, the operator or dispatcher arranges to dispatch a responding agency. A lack of authority response may result if a person reached at the premises is unable to provide a predetermined password. If an agency is dispatched, then the operator continues and notifies an RP of the dispatch at 400.

In the procedure of FIG. 6, the operator or dispatcher attempts to contact a single RP rather than a plurality of RPs. Attempting to contact a series of RPs may be counterproductive to the objective of providing a rapid response to an alarm signal. Therefore, if an RP is not reached at the first contact location, then no further attempts are made. In sum, the procedure of FIG. 6 entails a first contact (or attempt to contact) to verify the alarm and a second contact (or attempt) to notify the RP.

FIG. 7 illustrates an embodiment of the present system. When an alarm is received, at 100, then the present system, at 250, executes a program to automatically notify all RPs at every designated notification address. For example, with a home alarm system, the procedure at 250 may include simultaneously notifying, and seeking responses from, both spouses at their respective cell phones, work phones, e-mails, and fax numbers in addition to the home telephone. This provides an increased likelihood of reaching an authorized user, thus reducing the incidence of a false alarm while not unduly delaying the dispatch process. Similar responses are sought by the automated present system. If responses indicate that the alarm is to proceed to dispatch then a central station dispatcher handles the process 300. However, if the alarm is cancelled, then the present system automatically updates the RPs of this outcome at 450. Similarly, upon a dispatch 300, the present system is notified by the dispatch automation system of the dispatch, at 350, and then the present system notifies the RPs of the dispatch event. The process proceeds to conclusion 3000.

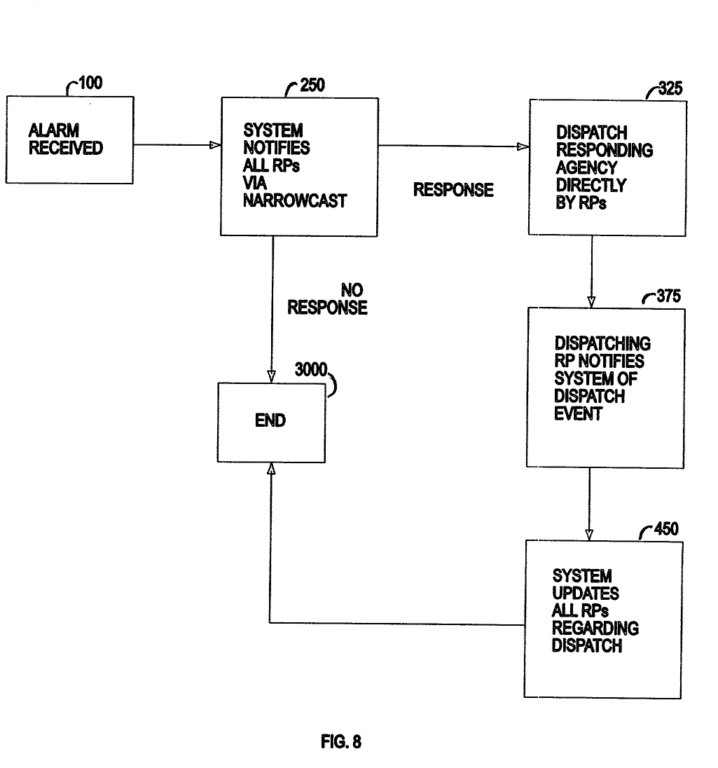

FIG. 8 depicts a further embodiment of the present system. At 100, an alarm signal is received. At 250, the RPs are notified. If the RPs, or any one RP, deems a response appropriate, then, at 325, an RP arranges to dispatch appropriate agencies directly. In one embodiment, the RPs notify other RPs that the dispatch occurred, at 450, by notifying the present system of the dispatch. The present system provides notification to the other RPs at 450. The process ends at 3000.

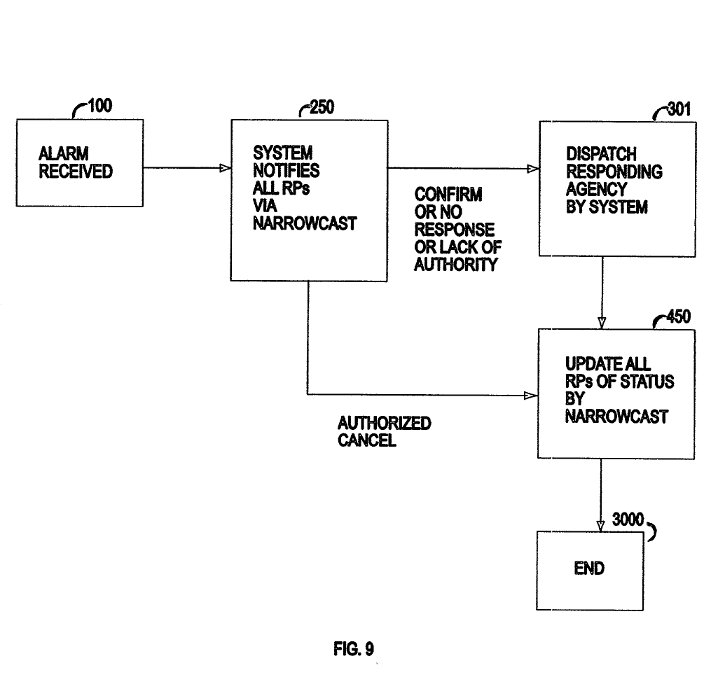

FIG. 9 depicts a further embodiment of the present system. In this embodiment, the responding agency is dispatched by the present system at 301.

Combinations of the foregoing embodiments are also contemplated. For example, an alarm user may choose a self-monitoring process as depicted in FIG. 8 that is backed up, if the user is unavailable, by dispatch operators as depicted in FIG. 7.

### Message Constriction

FIG. 10 depicts an embodiment that includes looking up account information by the present system. At 100, the present system receives the alarm signal and then looks up associated account information at 710. The account in formation, in one embodiment, includes information pertinent to the alarm condition and usable by the RP or agency to assess the events and develop a response. The information is then formatted from data fields into a message arrangement suitable for use by the notified party. In one embodiment, formatting includes adjusting construction to yield a sentence structure. For example, the fields “address,” “alarm description,” “event time” may be “906 East 1st Street,” “intrusion alarm at front door,” and “2:00 AM,” respectively. The textual data may be placed into a sentence such as for example, “there was an intrusion alarm at the front door at 2:00 AM” or the message may expect the fields to appear in a predetermined order, truncated to a certain length, separated by field delimiters, etc. to meet the requirements of the notified party. In one embodiment of the present system, a formatting template for each specific RP or agency is created to meet each one's individual requirements. In this embodiment, the look-up 720, and its associated database, incorporates information specific to managing the formatting issues.

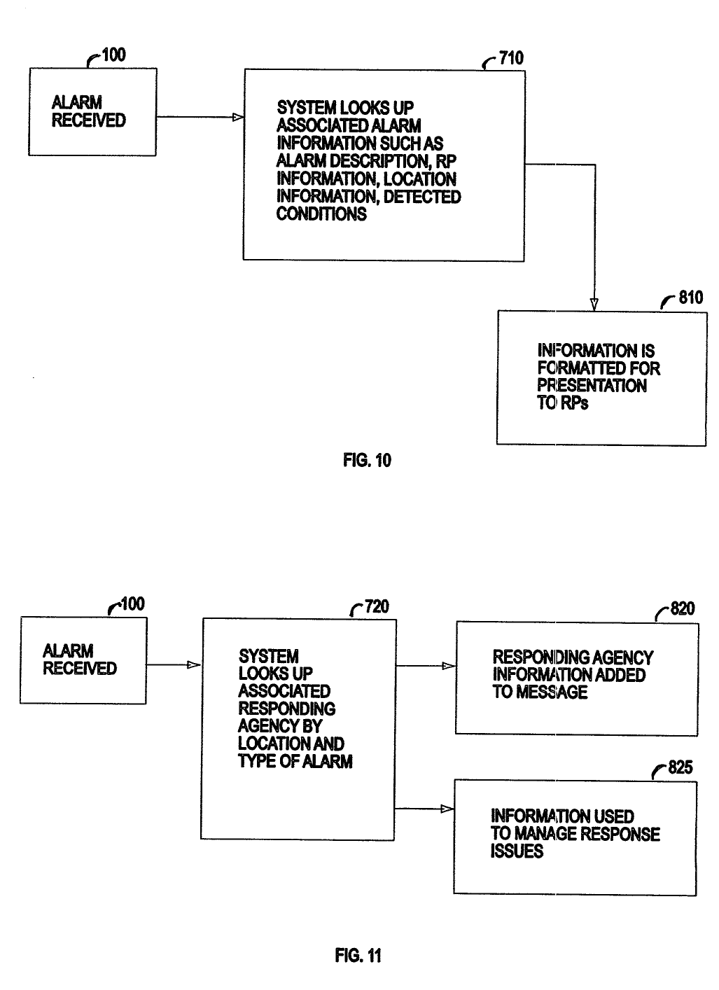

FIG. 11 illustrates one embodiment of the present system. The system illustrated includes a responding agency, such as a police department, a fire department, an emergency medical service, a hazardous material cleanup service, a maintenance provider, a locksmith, a roadside assistance and towing service provider or any other person or service that can assist with the alarm condition. The telephone numbers and messaging address information for the responding agency is stored in a look-up table accessible to a processor of the present system. The condition reported is pre-defined as associated with a type of responding agency.

At 100, the alarm signal is received. At 720, the present system begins a look-up of the associated responding agency. In one embodiment the responding agency information is provided to an RP for use in a self-monitored process. In one embodiment, the responding agency information is used to provide alarm information to the agency directly, as shown at 820. In one embodiment, the responding agency information is used to manage issues related to agency response issues, as shown at 825. In one embodiment, these issues include cost or payment for response, for example with a preauthorized credit facility. In one embodiment, these issues include filing required reports and forms with authorities having jurisdiction. In one embodiment, these issues include managing permit and license issues related to the responding agency or the alarm condition, premise or owner. Other administrative and related embodiments of the present aspect of this system are also contemplated.

Looking-up responding agency information may be accomplished according to several methods. For example, the responding agency may be pre-assigned to an account or event. The agency may be determined by comparison with a caller identification (caller-ID) or other alarm reporting information. The agency may be determined based upon boundary files, which are data representations of maps. Based upon a location, which may be determined by caller-ID, ANI, known address, reported location such as a latitude and longitude determined by GPS or other location system, the location is compared with the boundary file to determine the appropriate responding agency. There may be multiple boundary files for different types of responding agencies. For example, the jurisdiction of a police department may be different than the service territory of a towing provider.

In one embodiment, the responding agency information is added to the message information 820 or used to notify a responding agency.

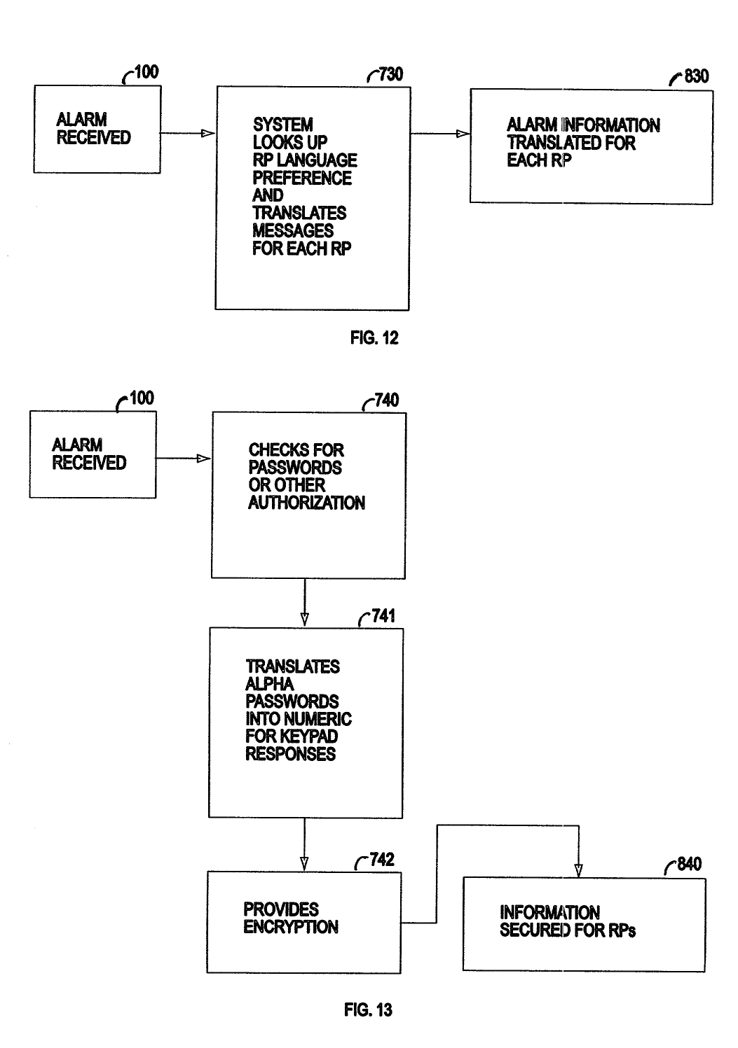

FIG. 12 depicts one embodiment of the present system. The present system and method allow automatic translation of messages into different languages. It is estimated that in the U.S.A. today, there are over 500 ethnic groups speaking over 600 languages. In one embodiment, the present system looks up the message language preference and then provides a translation of the message at 730. In one embodiment, the translation is provided by pre-selected message information. That is, the message information is provided in advance in a translated form. In one embodiment, the translation is made at the time of message construction. The translated message is then provided, at 830.

FIG. 13 depicts an embodiment of the present system that provides security related to the messaging. Security in the messaging system entails protection of the message and the authorizing of the response provided. In some cases, the message-receiving device functions as a key. For example, in one embodiment, a person's possession of a cellular telephone is their defined right to access and respond to a message and is analogous to the way a key can be used to open a door. In this security model, passwords may not be required to protect the integrity of a response.

In one embodiment, the present system contacts the alarm premise and offers a voice interface opportunity to cancel an alarm. In this embodiment, a password may be requested because a thief may be at the premise and answer the phone.

In addition to a password, other methods or tools can be used to authorize an unknown user. In one embodiment, voice prints or other biometric measures are used. In one embodiment, digital signatures are used to authorize a user. Other types of user authorization methods can be employed without diverging from the present invention.

FIG. 13 illustrates another embodiment. At 100, after the alarm is received, the present system looks up the password or other authorization, as shown at 740. In one embodiment, if the password is to be used on a device with a numeric keypad, such as a cell phone, then an alpha password is translated to match the keypad alpha convention, as shown at 741. The passcode may be specific to the account, the event, the RP, or the RP's specific contact device. The passcode may be translated to meet the needs of a specific device, for example, the password term “cat” may be translated to “228” on a telephone keypad to facilitate user entry.

In one embodiment, a WAP browser may provide more security than some of the other notification methods available with the present subject matter. A subscriber may be encouraged to use a WAP enabled device for their monitoring service.

In one embodiment, the present system provides security on the message itself. This security includes methods such as secure sockets or other encryption methods. At 742, the type of security designated is applied. Once all security is managed, the message is forwarded, as shown at 840.

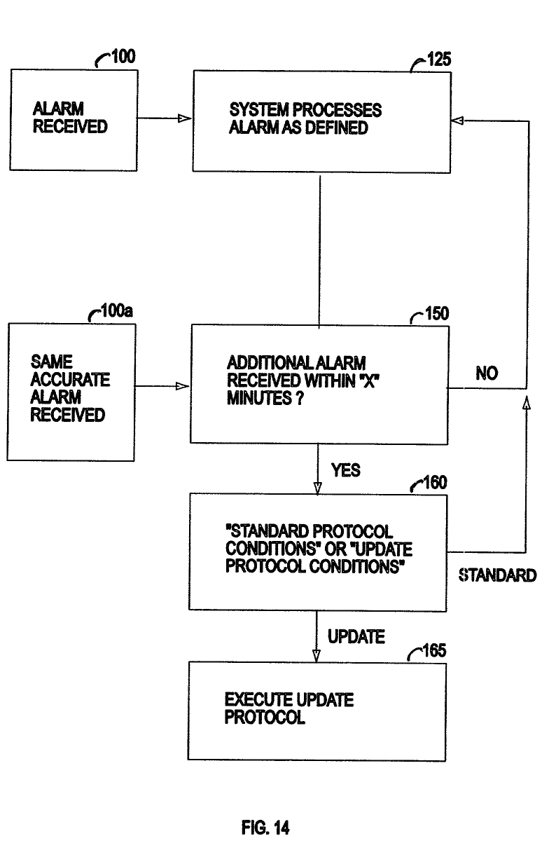

FIG. 14 depicts a further embodiment of the present system. Alarm events may be dynamic in that the alarm may not be just a single, discrete, event such as a door opening. For example, a burglary in process may include a continuing stream of signal information, such as motion detections or door openings. One embodiment of the present system provides for additional alarm messages for subsequent alarm events. At 100, the alarm is received. In one embodiment, the system processes the alarm according to the designated instructions. At 150, if, within a specified period of time, more alarm information is received on the same account, then the new information is deemed to be part of the same event. For example, a door opening followed within a few minutes by motion detection at the same location probably indicates a continuation of the same intrusion event. In various embodiments of the present system, this specified period of time is system defined, event type defined, or user defined.

At 160, and based upon user preferences, current processing status, and the alarm information received, the process may be adjusted on subsequent alarms for the same alarm event. For example, if the subsequent alarms are received before the first alarm is delivered, the message may include all alarms in one message.

As another example, if a user has already cancelled an alarm, a new, second alarm signal may be presented to the user with the entire designated process. This method may be used when the first alarm concerned motion detection and the user had cancelled because of recent experience with false alarm problems of the motion detector, and the second alarm was a door opening. When presented with this new information, the user may choose to override their previous cancellation and confirm the second alarm as real because the door opening indicates a likely intrusion, especially in combination with the motion detection.

As another example, if a user has already confirmed an alarm and dispatched a responding agency, new information from the second alarm signal may present no opportunity for the user to cancel because the system assumes the original event is genuine. However, the information may be of assistance to a responding agency.

Therefore, at 160, and based upon user preferences, current processing status, and the alarm information, an updated method protocol may be implemented for subsequent events.

In one embodiment, alarm related information involves switch activation and reporting. In one embodiment, alarm related information includes audio recorded at the location at the time of the event or a current audio connection to the location. Alarms may include video recordings, still pictures, or video feeds. Alarms may be associated with mobile persons, assets or vehicles and the location may be continually changing. Alarms may be associated with residential, industrial or commercial processes and may incorporate dynamic measurements such as changing temperature, viscosity, radiation or other levels.

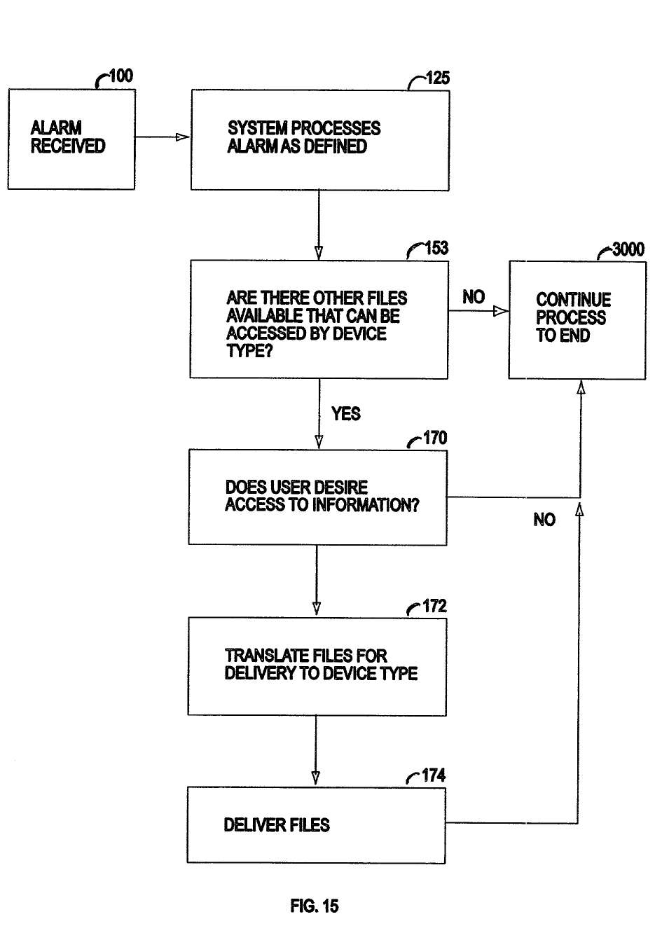

FIG. 15 depicts one embodiment of the present system. At 100, an alarm signal is received. At 125, the system processes the alarm as defined by the user. At 153, and while delivering alarm information, the system checks to determine if there are other alarm related data files that might be accessed by the user's messaging device type. For example, it may not be possible to deliver WAV sound files to a user device using SMS messaging. However, the user may be able to access past account history using SMS messaging. Therefore, at 70, the system determines if the user desires access to this information. If so, at 172, the information is translated to a format compatible with the user's device. For example, a WAV file may be delivered to a phone by playing the message for the user to hear. Then, at 174, the message or file is delivered.

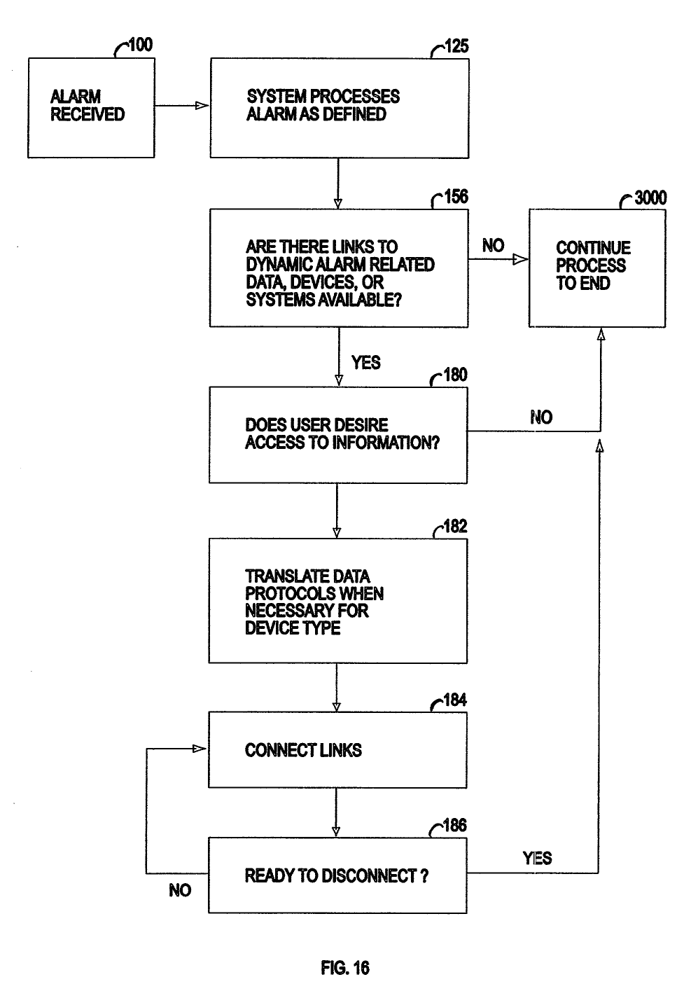

FIG. 16 illustrates one embodiment of the present system. Here, the information available from, or related to, the alarm is dynamic and present tense. For example, rather than a WAV file of a previous audio sound, there may be current audio links for a real time feed of sound from the alarm location. The process depicted in the figure includes, at 184, a link established to the current data, device, or system. Several types of links are contemplated, including voice, data, streaming media, Internet-based, switched circuit, packetized, etc. At 186, the user is offered an opportunity to continue or end the link.

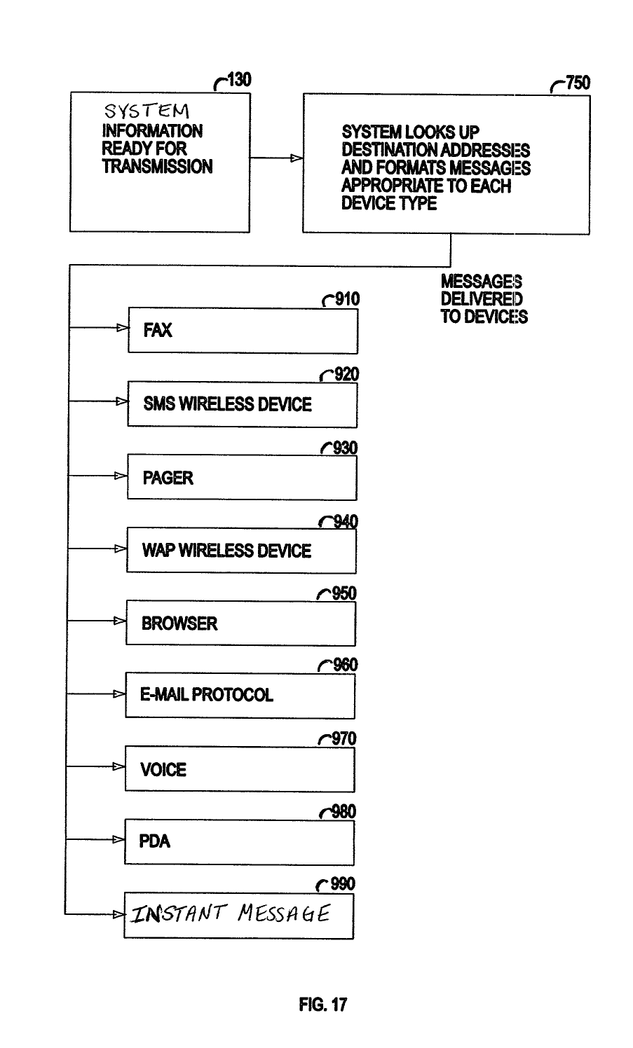

FIG. 17 depicts a process performed by the present system wherein the message prepared is formatted to match the communication protocol of the device to which it is delivered. The present subject matter can be tailored to communicate with a variety of wireless devices or systems. Exemplary devices and systems include, for example, but not by way of limitation, facsimile machine 910, short messaging service (SMS) to SMS device 920 using a telephone SMS address, pager 930 (one-way or two-way), WAP wireless device 940, browser 950 (Internet browser such as Internet Explorer by Microsoft or Netscape Navigator by Netscape), e-mail 960, voice 970, PDA 980 or instant messaging 990.

Protocol formatting includes such things as:

a) truncating messages to fit space or message length requirements of networks or receiving devices;

b) sending multiple messages to accommodate single message size requirements;

c) deleting attached files that are not appropriate for the message device to receive;

d) configuring data strings to be compatible with receiving devices or network requirements;

e) creating data structures compatible with receiving systems, such as Computer Aided Dispatch system at a response agency;

f) adding headers and footers, addresses and other requirements necessary to deliver messages in networks or to devices;

g) adding visual aids to make information more user-friendly, such as for presentation in a browser;

h) adding scripts to assist in the response to messages such as PERL, CGI, and Java Scripts; and

i) adding tracking information to aid in the management of responses and events.

In one embodiment, the outbound narrowcast message is generated and transmitted according to the following process steps:

a) the received alarm signal is checked against a predefined account file that defines the condition of an associated event;

b) the contact list for that specific alarm event (from that particular system) is accessed (in one embodiment, there may be multiple events and call lists per system);

c) multiple messages in multiple languages are generated pursuant to instructions in the account file;

d) the message is tailored for transmission according to the members on the contact list; and

e) multiple messages are transmitted.

Based upon the device specified for contacting, and based upon the communication network associated with the device, (for example there are multiple different types of SMS messages) then the message is formatted for transmission to that network. This formatting may include a text-to-speech generator for interactive voice.

### Response Management

In one embodiment, the present subject matter provide notification-only messaging. For example, the message may be recorded on a voice mail messaging system as a human voice. Some types of message methods are inherently one-way in design, such as, for example, one-way paging or faxing. In these cases, the message may include instructions for the user as to how to respond. For example, the message may include “call the following interactive voice system to take further action” or “connect to the following web address to respond to this event.”

In one embodiment, message notification includes an interactive element in that the user is prompted for data, and if provided, then the system provides further information. In addition, to safeguard the security or privacy of an RP, a password, or code may be requested before information is released or responses are accepted and other security may be employed.

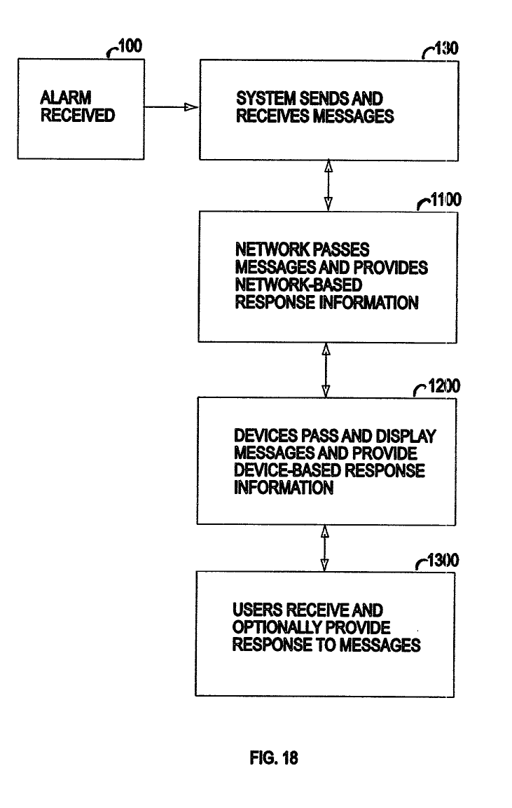

FIG. 18 illustrates an overview of response management according to one embodiment of the present subject matter. In the figure, four categories of responses are shown. They include, at 130, responses from the system itself, at 1100, responses from the network, at 1200, responses from the messaging devices, and at 1300, responses from the users. For liability purposes or event reconstruction purposes, data concerning the alarm notification is recorded in memory. The central station may record data exchanged with other services or people and record or track acknowledgments (ACKs) back from the network connections and to the device to show that the message was delivered or received. In some cases, it may be possible to confirm that the message was received by the customer. For example, the following types of data and transactions (and others) may be stored:

a) the time when the central station sent message to narrowcast service provider;

b) the time when narrowcast instruction passed a message to carrier network and received an ACK back;

c) the time when narrowcast service provider receives a response (or any information back) from customer;

d) the time when central station receives customer response from narrowcast service provider;

e) failure to communicate with narrowcast service provider may generate a high priority alarm event at the central station.

Responses may be tracked according to answer, busy, bad password, etc. Information regarding alarm notification may be stored in a memory, or history file 2200, accessible to the central station. Responses from within the present system itself may include, but is not limited to, the following examples:

a) alarm received information and history;

b) message creation information;

c) system and subsystem management, history and information;

d) interaction with a dispatch automation history and information;

e) system or message failures;

f) network non-responsive.

Responses from the network may include, but is not limited to, the following examples:

a) network acknowledgment of message receipt;

b) cellular tower message delivered from;

c) location of device delivered to;

d) fast busy, slow busy, ring-no-answer;

e) message routing information;

f) network fault codes.

Responses from the messaging device may include, but is not limited to, the following examples:

a) device acknowledgment of message receipt;

b) message opened by user;

c) answering machine detection;

d) handshake and kiss-off tones;

e) error or fault codes.

Responses from the user (through the device) may include, but is not limited to, the following examples:

a) entering touch tones to select menus and determine choices;

b) speaking words;

c) typing or entering data;

d) selecting menu items.

(For an interactive message, one embodiment entails performing the following process: the system provides multiple-choice responses to manage free form text response messaging. In other words, the user device allows entry of open, free form, text, and the present system prompts the user with a message such as “respond to this message with a “1a” to cancel the alarm or respond with a “2a” to confirm this alarm.”)

e) providing biometric entry, such as for example, a fingerprint reading, a face measurement, a voiceprint, or a retinal scan.

Examples of user, or RP, responses include, but are not limited to the following:

a) the RP may cancel the dispatch, verify the need for dispatch, authorize the dispatch or amend the dispatch instructions based on information received in the message;

b) enter a passcode (or password) or other authorization information;

c) alarm tracking information provided by dispatch agencies to use in follow up contacts;

d) message receipt;

e) notify user group of certain information;

f) authorize payment;

g) provide link to file or to dynamic live information;

h) update account information;

i) retrieve account information;

j) check or access account history;

k) check or access event history;

l) change alarm system programming;

m) change alarm system status (such as “arm,” “disarm” or “silence sirens”);

n) control appliances related to the location or the event.

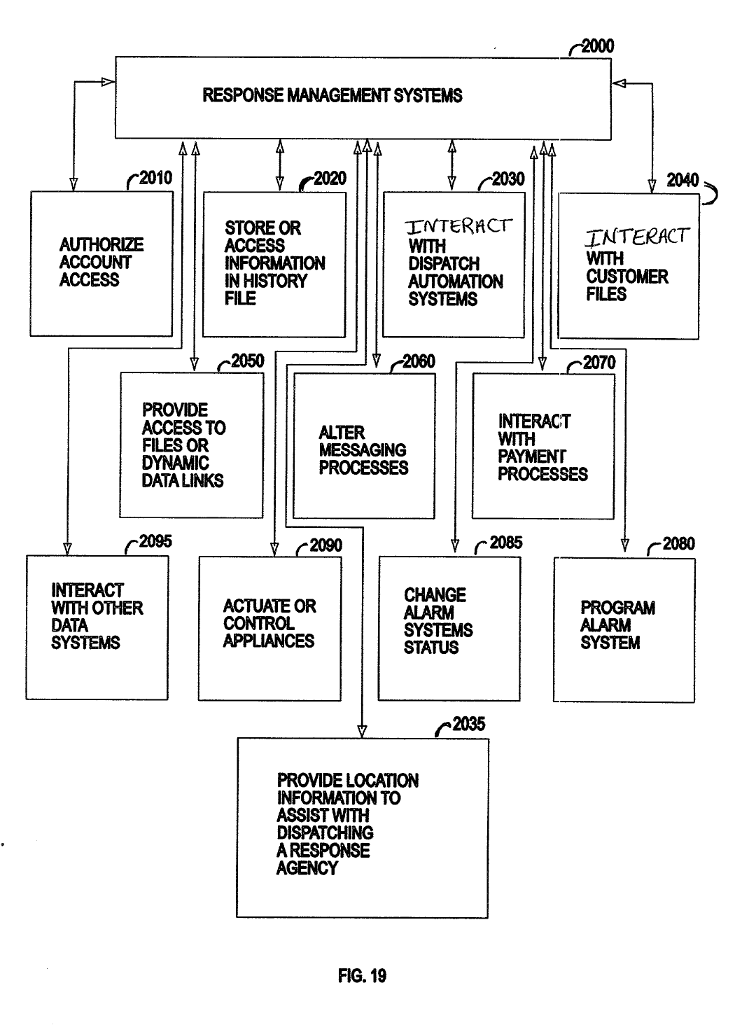

FIG. 19 illustrates the usage of response information by the response management system 2000 of the response information described herein in various embodiments of the present invention. Response management system 2000, in one embodiment, is a layer or module implemented in hardware, software or both and operates in conjunction with system 50. Examples of uses include, but are not limited to the following:

a) at 2010, authorize the account access or the user;

b) at 2020, all of these types of information are available to be entered in the history file associated with the account and the (event or retrieved for later event reconstruction;

In one embodiment, an acknowledgment message is recorded to indicate that the message was transmitted or received. The carrier message acknowledgments may be recorded in the customer file. In one embodiment, the carrier message includes a receipt indicating that a notification message was successfully delivered or read by a recipient. The acknowledgment may indicate that the network has received the message. The acknowledgment may indicate that the message was delivered to a particular device. The acknowledgment may indicate that an e-mail message was “opened” or viewed on a screen associated with the particular RP. The acknowledgment may include network related information. Other information may include system coding, network delays, busy signals, no-answer, answering machine answer, etc. Some or all of this information may be recorded in the customer history file.

In one embodiment, the RPs responses and message characteristics are recorded to a history file. For example, no response from a particular RP (but the message was received or answered), wrong password, time of response, multiple choice response received, incorrect response, selection, time-out condition, etc.

c) at 2030, interact with dispatch automation systems used by central stations or response agencies;

d) at 2035, provide assistance in identifying the location of an event requiring response. For example, such assistance may indicate that the message was delivered to a specific tower serving the RP. The tower identification provides an approximate location of the RP at the time of the message. In one embodiment, the location information may include a specific latitude coordinate and longitude coordinate for the RP.

e) at 2040, interact with customer information files to update information, retrieve information, or change status. Status may include such things as activating or deactivating an account, putting it in a test mode, or changing the status of specific alarm s or zones.

f) at 2050, response information may be used to provide access to files or dynamic links to current information;

g) at 2060, response information may alter the messaging process. Instructions received from an RP may be followed by the system. As outlined above, the instructions from the RP to the system may be executed. In some cases, the instructions entail notification of emergency agencies or other agencies, which may require human interaction because the agencies are not configured to receive automated notification or for other reasons.

In one embodiment, after instructions from an RP are completed, another round of notification may occur. In addition, selected RPs may be notified of the outcome of the process. For example, the notification may entail a message such as “the police were dispatched at 10:05 AM,” or “response was canceled by RP ‘Susan Smith’ or “RP Jones received message and acknowledged receipt.” In this manner, RPs are informed as to the outcome of the event.

Changes to the notification process are made based upon the carrier returned information. For example, if no RP is reached in a first attempt, a subsequent attempt may ensue. Also, based upon contacting one RP, efforts to contact additional RPs may be suspended. In one embodiment, if an answering machine is reached, then the format of the message may change from an interactive (response desired message) to a notification only message. If a person picks up the phone while the message is being delivered, the message may revert to an interactive message.

An RP may be presented with multiple choices regarding any specific condition on any specific account. For example, the RP may be empowered to cancel all further actions or to proceed with dispatching appropriate public or private agencies. The system may be configured to attempt to notify those RPs appearing on contact list A of the event or alternatively attempt to notify contact list B of the event or alternatively attempt to notify those on contact list C.

These options to notify various contact lists allow an RP to select various outcomes. For example, a user may know that a first person on the contact list is unavailable and therefore, the system should attempt to notify a second person.

h) at 2070, response information may interact with payment processing;

i) at 2080, response information may be used to provide programming changes to the alarm system 2080. For example, the user may want to change access codes or allow temporary access to a service person. For example, programming may be accessed via a wireless link, a modem, an Internet connection or other methods. In addition to the users presented in FIG. 4, a user may also include system 50.

j) at 2085, responses may be used to change alarm system status. For example the user my desire to “arm,” “disarm” or “silence sirens.” Some of the methods used to access the alarm system may be through dial-up modem, through the Internet, over wireless links, or when the alarm system connects to the central station to report alarms. For example, in one embodiment, system 50 includes programming to communicate a “silence” command to the originating alarm and cause the audible alarm signal to be terminated.

k) at 2090, response information may be used to actuate or control appliances. This control may be through the alarm system at the premise or through an independent system.

l) at 2095, response information may be used to connect to external data sources 2095. The response information may provide the authorization to these data sources, or it may receive or send data to these external data sources. In one embodiment, the receipt of data from an external database is a response type.

In one embodiment of the present system, response protocols are predetermined. For example, the actions taken in response to information as described above, can be taken automatically based upon a time delay a schedule, a series of actions, a lack of response, a pre-selected protocol, an agreed upon price, a requirement of a dispatching jurisdiction, etc.

In one embodiment, a timer buffer is used to provide response management. An RP may have a fixed period of time allocated with which to respond to an event. For example, in the case of a fire alarm signal, the user may designate that no more than two minutes are allowed to pass in waiting for a response, because of the risk to life and property. The time period can be set differently for each account, or each event type for the account. For example, a user may want a faster response time for fire than for burglary or an unauthorized opening of a safe may be have a shorter response time period than an unauthorized opening of a medicine cabinet. Some events may not include a time out period. For example, the condition may not be time-critical.

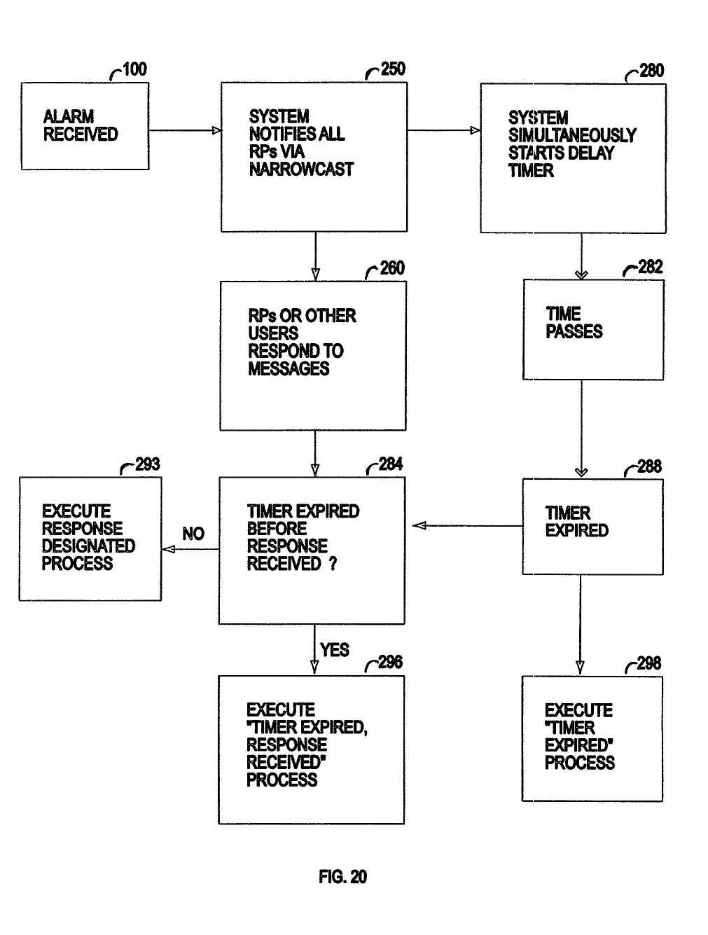

FIG. 20 illustrates an embodiment of the timer buffer to manage RP and other user responses. At 100, the alarm is received. At 250, the system begins the notification and other procedures. At 280, occurring at the same time, the system starts a delay timer and sets the time limit. At 282, time passes while waiting for RPs to receive, respond, and return receipt to occur. At 260, if RPs respond before time elapses, then the system executes the designated process 293 as indicated by the RP response. If, at 288, the timer expires before any responses have been received, then, at 298, the default timer expired process is executed. For responses that are received late, that is, after the timer expires 288, then the management of those processes occurs according to process designated at 296. In one embodiment, the process is user selectable and can be adapted for each RP, each account, and each alarm for the account.

In one embodiment, an RP may be offered multiple pre-selected options based upon a time-out condition, that is, the time period has elapsed with no response received at 298. For example, the system may proceed with dispatching public safety agencies. This may be a default, fail-safe mode of operation. As another example, the system may not dispatch unless response is provided indicating the need to do so. As another example, if no response is received, then the system may attempt to notify alternate RPs. In one embodiment, these options are selectable and customizable by account or by specific alarm condition.

If there is no response from the customer or if the customer sends a “confirm” message, then the alarm signal is sent to the central station buffer to be processed by a dispatcher. In one embodiment of the present invention, to avoid delay, the signal may be placed in priority order according to the original time the signal is received, at 100, and not the time that it was released, at 293 or 298. In one embodiment, alarm signals are processed based upon the time each signal arrives at the receiver.

In one embodiment, the present system sets priority event codes to manage the order of processing when an aspect of the system such as dispatcher labor availability, network capacity, or processing power may be overloaded. In this embodiment, high priority events, such as high-rise fires or bank robberies, are processed before lower priority items, like residential burglaries, even if the higher priority events are received after the low priority events. In one embodiment, processing of alarms is conducted on the basis of first in, first out.

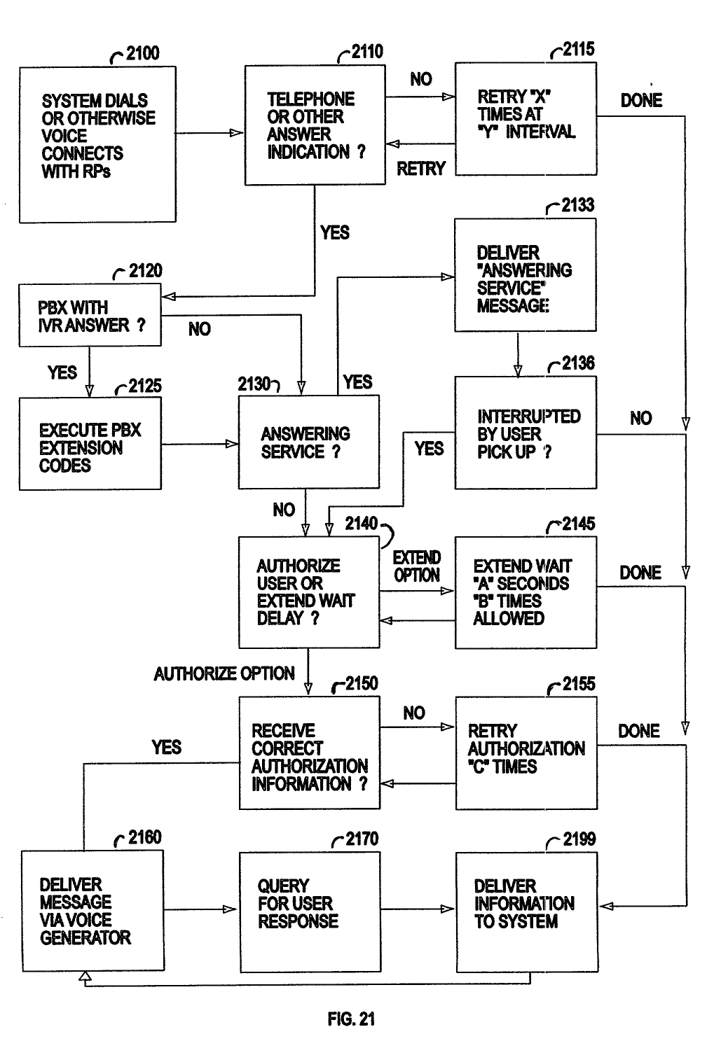

FIG. 21 illustrates one embodiment, involving interactive voice, of the query and response aspect of the present system. This embodiment may be used with users to process message delivery and query the users for response or other interactions. In one embodiment, the type of process is similar to those used to interact with WAP devices, browsers, or with SMS messaging. In one embodiment, the processes may be initiated by RPs and other users connecting to the present system, instead of initiated by the present system connecting to RPs.

In one embodiment, interactive voice response (IVR) technology is used to recognize a human voice answering a telephone. When the telephone is answered, the interactive voice message may respond with a message such as, “You have an alarm message waiting. Please enter your password to receive it or press ‘###’ to extend time 20 seconds.” The user then either extends the time or enters the password. When the password is entered, the message is delivered. The user is queried for response and possibly additional messages and queries are then delivered and executed.

Consider the following exemplary scenarios regarding interactive voice.

a) If a child or other person without alarm authority answers the telephone then various outcomes are possible. One embodiment provides for creation of a series of timeouts. For example, a message that says, “Please press one to continue to hold,” may be repeated every 15 seconds. If a responsible party has not entered their passcode within a specified time period, then the system announces that the call will be terminated and subsequently disconnects.

b) If the system reaches an answering machine, then, in one embodiment, the system automatically switch to an alternate message such as, “message B” stating there is an alarm message waiting and leaving a callback telephone number to the system or other facility.

c) In the event that human intervention interrupts a message being left on voice mail (or on an answering machine), then, in one embodiment, the system reverts to an alternate message. In one embodiment, the called party can enter a number code using the telephone keypad and access an interactive alarm menu.

d) In the event that a telephone PBX is reached, then, in one embodiment, the system is configured to access a particular predetermined telephone extension. This may be encountered when calling the customer at his or her place of business.

e) Multiple passcodes, or passwords, are also contemplated, with each passcode configured for a particular type of alarm condition or other parameter.

A customized script allows cancellation of services. This script allows the customer to enter their passcode and cancel, confirm, or change the alarm event.

In one embodiment, two types of messages are created for the voice system. The first is a notification message and the second is a response message. A notification message provides information and a call back telephone number. A response message allows the customer to enter a touch tone response such as confirm or cancel. In one embodiment, messaging scripts are created for the high percentage of canned, or prerecorded, notifications anticipated. In ore embodiment, text-to-voice technology permits customization of other messages.

The system and method includes a program that integrates with the automation software. This program automatically creates the numeric equivalent of a password. Alternately, the system can also recognize a number that is related to a word automatically. The number 228, for example, may represent the password CAT.

With e-mail, the customer receives a Uniform Resource Locator (URL) with an embedded Common Gateway Interface (CGI) or other script to click on. In one embodiment, the name, event code, and other information is already pre-entered and the customer is prompted to type in their passcode. After entering the requested data, the alarm information is presented to the customer with a script that is unique to that event. From there, the customer may cancel, confirm, or change the alarm event.

In one embodiment, the present system confirms an instruction or confirmation back to the customer.

FIG. 21 illustrates an example embodiment for an interactive voice arrangement of the present system. At 2100, the present system dials, or otherwise voice connects, with RPs or other users. Different types of voice connections are contemplated, including Voice Over IP, dial-up connections, GPRS and other cellular connections. In addition, the user may initiate the connection instead of the present system. At 2110, the system attempts to detect an answer such as YES, or other indications or NO, such as busy signal, unanswered ringing, or no response. If NO, then the system redials for ‘x’ number of times at ‘y’ intervals. If no connection occurs within specified number of tries, then “done” is reported at 2199. If YES, then the method proceeds to 2120.

At 2120, the system next, detects or is pre-programmed to manage a PBX system if required. If so, the present system executes extension and IVR codes to connect to the correct user.

If there is no PBX 2120—NO, then in one embodiment the present system, at 2130, detects whether there is an answering service answering the connection. If so 2130—YES, then a message appropriate for an answering service or machine utilized by this user is delivered at 2133. For unsecured answering machines, such as are often used in residences, the message left is available to be heard by anyone in proximity. In one embodiment, the message left is brief and limited in scope since a thief may be present in the home. However, if it is a secure answering service, a complete message may be left for retrieval by the user at 2133. The leaving of the message may be interrupted by the user at 2136. This may occur, for example, by the user picking up a telephone, entering a code or touch-tone or speaking a word. If the message is left without interruption, then this information is relayed back to the main system at 2199.

Once a live user is on the telephone line, the present system provides user options at 2140, which, in one embodiment, includes an option to “extend” or “authorize.” In one embodiment, the user is given the opportunity to extend the time at 2145 (allowing, for example, sufficient time for a first person to hand the telephone phone to an authorized user). In one embodiment, multiple time extensions may be allowed. In one embodiment, the user is given the opportunity to provide authorization information, at 2150, to receive the alarm message. In one embodiment, no authorization is required to receive limited or all related information. If incorrect authorization information is provided, the user is allowed to retry authorization ‘c’ times, at 2155. Failure to correctly provide authorization is reported back to the system at 2199.

Once an authorized user has been connected, then the alarm information is delivered. Next, at 2170, the user is queried for responses or allowed access to other menu items as described herein. Information is delivered and exchanged and authorized at 2199.

### System Architecture

One embodiment of the present subject matter includes multiple interconnected servers, applications and databases. In one embodiment, additional servers exist in a virtual machine environment on the same piece of hardware and in one embodiment, multiple servers exist as separate pieces of hardware.

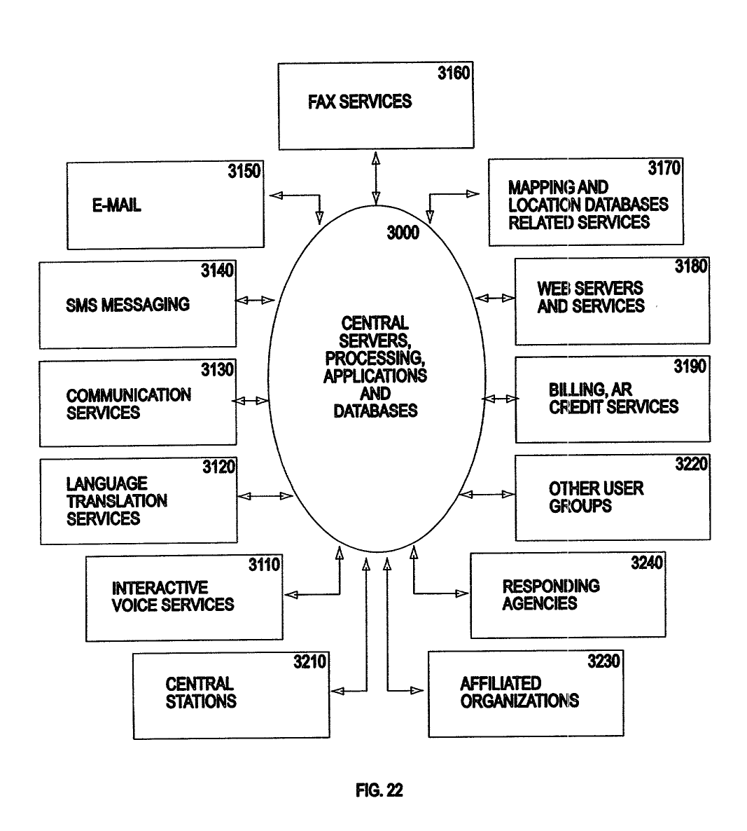

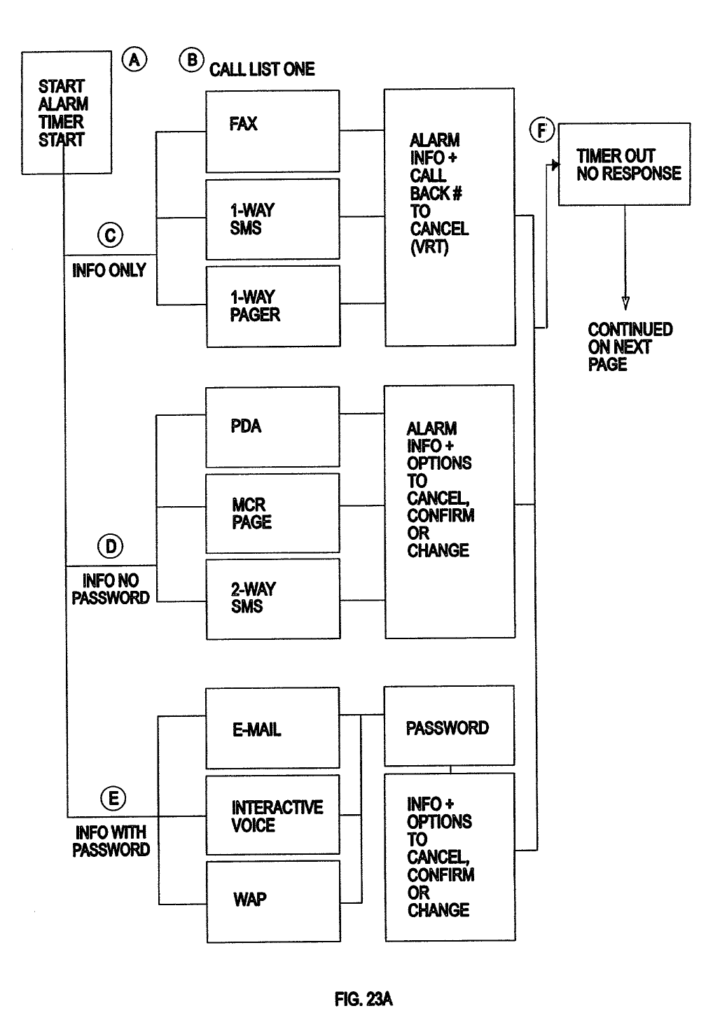

One embodiment of the present subject matter includes distributed processing. FIG. 22 depicts a block diagram showing distribution of selected processing elements among multiple service providers. Each service provider may include in their service offering aspects of communication networks, hardware, application software and processing, and databases. In this way, the present system is distributed among multiple service providers and systems. One embodiment includes service providers providing communication networks, hardware, application software and processing, and databases including but not limited to the following:

a) interactive voice services, at 3110;

b) language translation services, at 3120;

c) communication services, at 3130;

d) SMS Messaging, at 3140;

e) e-mail Services, at 3150;

f) FAX services, at 3160;

g) mapping and location databases related services, at 3170 (may include access to yellow pages, telephone directories, navigation, nearest services, etc.);

h) web servers and services, at 3180;

i) billing, accounts receivable, and credit management services, at 3190;

In addition, in one embodiment, distributed processing accesses information stored, collected, processed or otherwise available in other systems. For example, the customer name, address, and contact list may be stored in whole or in part in the central station. The central station dispatching system may include the customer name, address, history file, contact list, and/or alarm signal processing in whole or in part without need for storing duplicate information.

In one embodiment, distributed processing includes connection to the following:

a) central stations, at 3210 (discussed herein);

b) other user groups, at 3220 (in one embodiment, other service providers access the present system in addition to central station dispatch operations. These may include businesses or individuals that desire to use the messaging or processing capabilities beyond alarm processing. For example, disaster recovery teams, volunteer firemen, maintenance groups, construction work subject to weather conditions, and others);

c) affiliated entities, at 3230 (entities such as insurance companies, clubs, organizations and other businesses may choose to offer their customers alarm systems and other services. In one embodiment, a user includes an affiliated organization);

d) responding agencies, at 3240 (other response agencies such as roadside assistance providers, hazardous material spill cleanup, police departments, etc. In one embodiment, a user includes a responding agency).

In one embodiment, distributed services are processed between service providers without connecting back through the present system 4000. For example, interactive voice service provider 3110 may connect to language translation 3120 without connecting back to center 4000.

One embodiment includes establishing a connection with various network-operating centers. For example, a connection is established between various carriers' centers and the central monitoring center.

In one embodiment, the process of formatting and transmitting the message occurs using various service providers. Various service providers can separately manage language translation, connection to various wireless messaging, text-to-speech interactive voice, broadcast fax messaging, web services, WAP services, etc. The message is created and delivered according to the capabilities and features of the network.

In one embodiment, the interconnection between service providers occurs using various data exchange methods using various protocols, including TCP/IP, XML, ASCII and Unicode text.

In one embodiment, databases are connected to directly using ODBC tools, directories, opening a port, or other methods.

In one embodiment, the connection between service providers is via Internet, frame relay, satellite, dial-up, or other means.

In one embodiment, the messages are sent to the various carrier services.

### Billing Management and Method

In one embodiment, customer billing for the present system is based upon a charge per message per device type. Each device type may have different charges associated with it. For example, it costs more to conduct an interactive voice call over long distance than to send an e-mail.

In one embodiment, the present subject matter includes creating a message package suitable for a particular market. For example, an average residential customer monitoring burglary signals may use a particular monitoring package having a particular structure such as, for example:

a) a contact list long enough to meet a sufficient number of RPs at a sufficient number of RP devices;

b) an allocation of usage sufficient to satisfy most accounts (that is, number of activations).

In one embodiment, additional service packages are available in unitary increments if the subscriber (user) opts to purchase additional coverage or if the purchased coverage is exceeded. Coverage can be exceeded if the allotted number of activations in a specified period is exceeded.

For example, in one embodiment, a single package includes a menu of address options such as:

a) 4 each e-mail addresses;

b) 1 FAX telephone number;

c) 3 interactive voice telephone numbers;

d) 2 SMS or pager connections.

In one embodiment, the subscriber is offered a base number of activations per period of time (such as a month) for a fixed price per month.

If a subscriber selects more message destinations, then they can purchase an additional message package(s) whether they use every type of message destination or not. If they exceed the base number of messages in a month, they are charged in whole message packages.

In one embodiment, various packages are offered with different numbers of message destinations or numbers of base messages per period.

In one embodiment, packages are structured in groups to meet different needs. For example, some customers may prefer primarily interactive voice messaging while other customers may prefer primarily electronic forms of communication such as e-mail.

In one embodiment, packages are structured based upon message costs. For example, in one embodiment, inexpensive forms of messaging are bundled together, and moderate costing forms are grouped together.

In one embodiment, management of billing for the central station(s) is provided. For example, one embodiment includes:

a) a system for creating system packages and tracking;

b) an ability to track signals in excess of a predetermined quantity;

c) an ability to identify customers who are using the present system and dispatch verification at the same time.

### Sample Embodiment

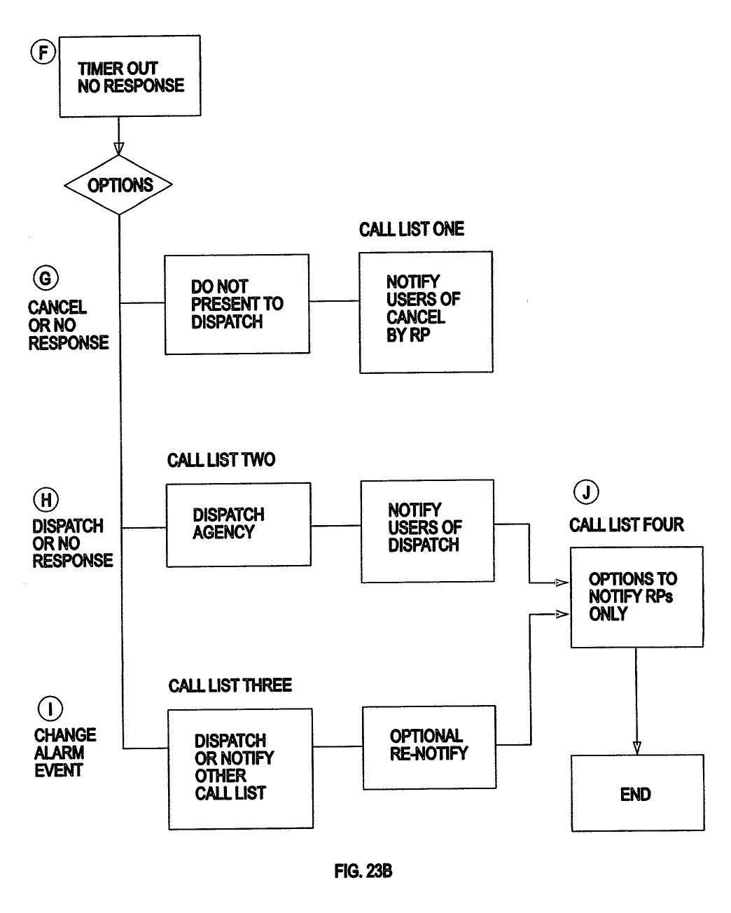

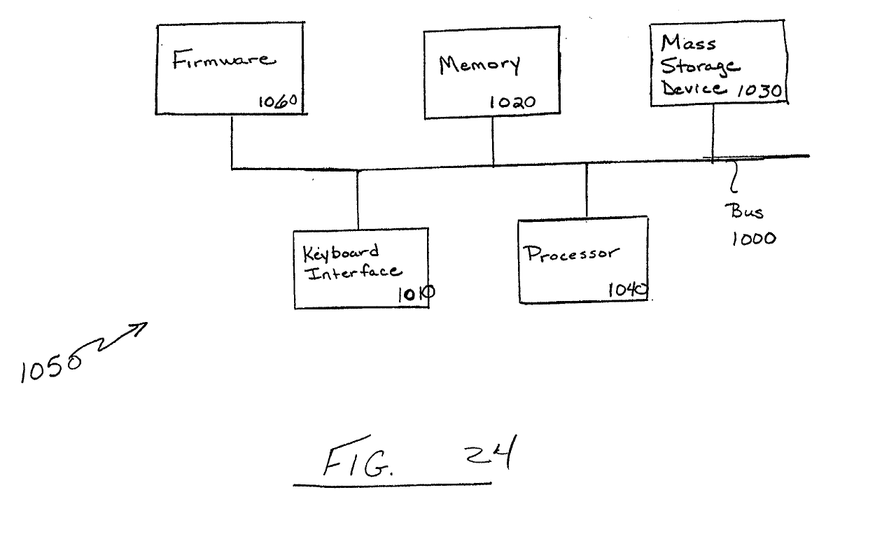

The following description refers to FIG. 23A and FIG. 23B.

A. Start Alarm

When an alarm event is detected, the alarm signal is sent to the central station. Upon receipt of the signal by the central station, a timer starts. In one embodiment, the timer includes a system timer. The duration of the Timer is set with defaults across the system by event code. The duration can be changed by account number, zone, or alarm dealer number. (The same is true of the response occurrence.) In one embodiment, the duration of the timer is approximately two minutes, thirty seconds.

B. Call List One

This is a first list of Responsible Parties (RPs) that is supplied by the customer (or subscriber). These are persons authorized to cancel, confirm or amend related alarm events. In one embodiment, a particular RP is authorized to confirm an alarm but not authorized to cancel an alarm. In one embodiment, the customer is also an RP.

C. Information Only

In one embodiment, the central station sends a one-way message to the customer via fax, one-way SMS, or one-way pager. The customer receives a description of the alarm and a call-back telephone number to cancel the alarm. The call-back number connects to an automated voice response technology system or interactive voice system. After entering the account number and passcode, the customer (or RP) may confirm, change, or cancel the alarm. Passwords or passcodes can be entered via a telephone as each letter is represented by a number on the telephone key pad.

D. Information to Cancel/No Password

In one embodiment, the central station sends a text message to the customer in a one-way format with coded response options (such as 111 to cancel, 222 to confirm, etc.). This message is sent via the customer's PDA (such as a Blackberry or Palm Pilot VII), MCR page, or two-way SMS device. The customer receives a description of the alarm along with options to allow confirmation, changing, or canceling of the alarm. The central station may be unable to receive free-form text instructions from the customer and thus, the coded response options described here provide a method to communicate a specific response to the central station.

E. Information to Cancel/ With Password

In one embodiment, the central station sends a two-way message to the customer via e-mail, Interactive Voice Response System, or WAP device. The customer receives a description of the alarm and options to confirm, change, or cancel the alarm. The central station automation software then processes the alarm according to the instruction received and has the customer's password for verification purposes.

F. Timer Out

If the central station receives no response from the customer by the time the timer has run out of time, the alarm is either automatically logged into the central station system or presented to a dispatcher for processing. The dispatcher follows one of three possible response sequences as described in G-I. Response sequences are predetermined by the customer upon registering for service using the present system. The response sequences (cancel, confirm, or change) have global defaults by event code, but can be changed by dealer, account number or zone.

G. Cancel or No Response

In one embodiment, the central station receives a cancel message from the customer. In this instance, a second message is sent by the central station to all RPs on Call List One via previous methods of communication. This second message relays the alarm information and a note specifying who canceled the alarm.

In one embodiment, the central station automatically cancels the alarm if no response is received within the allotted time if the customer has previously given instructions to do so in this circumstance. Following these instructions, a second message is sent by the central station to all RPs on Call List One via previous methods of communication. This second message relays the alarm information and notification of automatic cancellation of the event.

H. Dispatch or No Response

In one embodiment, the central station receives a confirm message from the customer. In this instance, the alarm is presented to a dispatcher for processing according to account instructions (Call List Two). In one embodiment, the second call list includes dispatching the appropriate emergency agency and then notifying the RPs on the account.

In one embodiment, the central station automatically proceeds, to Call List Two if no response is received within the allotted time if the customer has previously given instructions to do so in this circumstance. Following these instructions, the alarm is processed the same was as if a confirm message was received (as described above).

I. Change/Dispatch or Notify Alternate Call List

In one embodiment, the central station receives a change message with instructions from the customer. According to account instructions, in this case, alarm information and a message is sent to RPs on Call List Three. This third call list may include the service company, for example, which the customer may want to notify in case of technical problems with their alarm system. Alternately, this alarm event may be processed by a dispatcher, depending on the options predetermined by the customer.

J. Notification of Responsible Parties Only

In one embodiment, an RP does not have authority to cancel, confirm, or change alarms events. RPs may be persons that the customer designates are to be informed of specific events. Examples of RPs who may not have alarm authority include a Regional Sales Manager for a commercial business chain or a neighbor who can go to the premise to meet the police if needed.

As illustrated in the flow chart, the customer may elect to be sent a message indicating the result of processing the alarm event according to their instructions on Call List Two. This is an optional notification that the customer may elect upon registering for monitoring services. If this option is elected, the central station will notify the RPs as listed on Call List Four.

FIG. 24 includes a block diagram of a system, such as a computer system 1050, of an example embodiment of the present subject matter. Computer system 1050 includes bus 1000, keyboard interface 1010, external memory 1020, mass storage device 1030, processor 1040 and firmware 1060. Bus 1000 may be a single bus or a combination of multiple buses. Bus 1000 provides communication links between components in the system. Keyboard interface 1010 may be a dedicated device or may reside in another device such as a bus controller or other controller. Keyboard interface 1010 allows coupling of a keyboard to the system and transmits signals from a keyboard to the system. External memory 1020 may comprise a dynamic random access memory (DRAM) device, a static random access memory (SRAM) device, or other memory devices. External memory 1020 stores information from mass storage device 1030 and processor 1040 for use by processor 1040. Mass storage device 1030 may be a hard disk drive, a floppy disk drive, a CD-ROM device, or a flash memory device or the like. Mass storage device 1030 provides information to external memory 1020. Firmware 1060 is nonvolatile memory programmed with data or instructions. Examples of firmware 1060 include, but are not limited to, read-only memory (ROM), programmable read-only memory (PROM), and electrically erasable programmable read-only memory (EEPROM), and flash memory.

In one embodiment, the present subject matter can be used with instant messaging service. Instant messaging refers to, among other things, a networked communication service for exchanging notes in the context of a private chat room session. In one embodiment, instant messaging system provides notification to a user when another person is available for communications.

In one embodiment, the present subject matter utilizes instant messaging to notify one or more RPs of an alarm condition or event. In one embodiment, the present subject matter utilizes instant messaging to receive an instruction or acknowledgment from an RP. The responding agencies may communicate with an RP, or the present system, using instant messaging. An instant message address may appear on a call list for a particular RP. Notifications, confirmations, cancellations, responses and other messages may be communicated using instant messages.

### Conclusion

Other embodiments are possible and the examples provided herein are intended to be demonstrative and not exclusive or exhaustive of the present invention, which is determined by the scope of the appended claims and the full range of equivalents to which they are entitled.

What is claimed:

1. A method comprising:
receiving a plurality of messaging device addresses for contacting a plurality of responsible parties associated with a detected condition;
receiving notification that the detected condition exists;
executing a first computer program to encode a message based on the detected condition;
executing a second computer program to transmit the message to each of the plurality of messaging device addresses; and
receiving a first instruction from a first responsible party from the plurality of responsible parties.

2. The method of claim 1 further comprising executing the first instruction.

3. The method of claim 1 wherein executing the second computer program to transmit the message to each of the plurality of messaging device addresses includes executing the second computer program to substantially simultaneously transmit the message to each of the plurality of messaging device addresses.

4. The method of claim 1 further comprising transmitting a notification to the plurality of responsible parties acknowledging receipt of the first instruction.

5. The method of claim 4 further comprising executing a third computer program to transmit the notification.

6. The method of claim 1 further comprising transmitting a notification to the plurality of responsible parties confirming execution of the first instruction.

7. The method of claim 6 further comprising executing a third computer program to transmit the notification to the plurality of responsible parties.

8. The method of claim 1 wherein receiving a plurality of messaging device addresses includes receiving a telephone number.

9. The method of claim 1 wherein receiving a plurality of messaging device addresses includes receiving an e-mail address.

10. The method of claim 1 wherein receiving a plurality of messaging device addresses includes receiving a pager telephone number.

11. The method of claim 1 wherein receiving a plurality of messaging device addresses includes receiving a telephone short messaging service (SMS) address.

12. The method of claim 1 wherein receiving a plurality of messaging device addresses includes receiving a facsimile telephone number.

13. The method of claim 1 wherein receiving a plurality of messaging device addresses includes receiving a trunked radio frequency.

14. The method of claim 1 wherein receiving a plurality of messaging device addresses includes receiving an instant messaging address.

15. The method of claim 1 further comprising transmitting a request to a public safety answering point (PSAP).

16. The method of claim 15 further comprising executing a third computer program to transmit the request to the PSAP.

17. The method of claim 1 wherein receiving the instruction from the first responsible party includes receiving authentication of authority from the first responsible party.

18. The method of claim 17 wherein receiving authentication includes receiving a password.

19. The method of claim 17 wherein receiving authentication includes receiving a biometric measurement.

20. The method of claim 17 wherein receiving authentication includes receiving a voice print.

21. The method of claim 1 wherein receiving notification that the detected condition exists includes receiving notification from a dispatch automation system.

22. The method of claim 1 wherein receiving the plurality of messaging device addresses includes receiving the plurality of messaging device addresses from a dispatch automation system.

23. The method of claim 1 further comprising executing a second instruction if the first responsible party does not respond within a predetermined period of time.

24. The method of claim 1 further comprising transmitting a data file to the first responsible party, wherein the data file relates to the detected condition.

25. The method of claim 24 wherein transmitting the data file includes transmitting a WAV file.

26. The method of claim 24 wherein transmitting the data file includes transmitting an image file.

27. The method of claim 24 wherein transmitting the data file includes transmitting an audio file.

28. The method of claim 24 wherein transmitting the data file includes transmitting a video file.

29. The method of claim 24 wherein transmitting the data file includes transmitting a measurement.

30. The method of claim 24 wherein transmitting the data file includes transmitting an instant messaging address.

31. The method of claim 24 wherein transmitting the data file includes transmitting location information.

32. The method of claim 24 wherein transmitting the data file includes transmitting information relating to responding agency.

33. The method of claim 1 further comprising transmitting a link to the first responsible party, wherein the link relates to the detected condition.

34. The method of claim 33 wherein transmitting the link includes transmitting a hyper link.

35. The method of claim 33 wherein transmitting the link includes transmitting an audio link.

36. The method of claim 34 wherein transmitting the link includes transmitting a link to a responding agency.

37. The method of claim 1 further comprising transmitting a data file to a responding agency, wherein the data file relates to the detected condition.

38. The method of claim 37 wherein transmitting the data file includes transmitting a WAV file.

39. The method of claim 37 wherein transmitting the data file includes transmitting an image file.

40. The method of claim 37 wherein transmitting the data file includes transmitting an audio file.

41. The method of claim 37 wherein transmitting the data file includes transmitting a video file.

42. The method of claim 37 wherein transmitting the data file includes transmitting a measurement.

43. The method of claim 37 wherein transmitting the data file includes transmitting location information.

44. The method of claim 37 wherein transmitting the data file includes transmitting an instant messaging address.

45. The method of claim 37 wherein transmitting the data file includes transmitting information related to the first responsible party.

46. The method of claim 45 wherein the information includes a telephone number.

47. The method of claim 45 wherein the information includes an instant messaging address.

48. The method of claim 1 further comprising transmitting a link to a responding agency, wherein the link relates to the detected condition.

49. The method of claim 48 wherein transmitting the link includes transmitting a hyper link.

50. The method of claim 48 wherein transmitting the link includes transmitting an audio link.

51. The method of claim 48 wherein transmitting the link includes transmitting a link to communicate with the first responsible party.

52. The method of claim 1 further comprising processing payment information from the first responsible party.

53. The method of claim 1 further comprising transmitting an alarm control signal to change an alarm system status.

54. A system comprising:
a processor;
an alarm system interface coupled to the processor and adapted to receive an alarm signal;
a memory accessible to the processor and having stored thereon one or more notification addresses for one or more monitored detectors;
an outgoing message means adapted for processor control and adapted to transmit an alarm notification message to each of the one or more notification addresses based on receipt of the alarm signal;
an incoming message means adapted for processor control and adapted to receive one or more responses based on the alarm signal; and
wherein the processor executes an instruction received by the incoming message means.

55. The system of claim 54 wherein the alarm system interface includes a telephone interface.

56. The system of claim 54 wherein the outgoing message means includes a telephone interface.

57. The system of claim 54 wherein the outgoing message means includes an Internet connection.
